(19) United States
(12) Patent Application Publication
(10) Pub. No.: US 2007/0133733 A1
(43) Pub. Date: Jun. 14, 2007

(54) Method for developing nuclear fuel and its application

(76) Inventor: Liviu Popa-Simil, Las Alamos, NM (US)

Correspondence Address: BUCHANAN, INGERSOLL & ROONEY PC, POST OFFICE BOX 1404, ALEXANDRIA, VA, 22313-1404, US

(21) Appl. No.: 11/603,812

(22) Filed: Nov. 21, 2006

Related U.S. Application Data
(60) Provisional application No. 60/748,489, filed on Dec. 7, 2005.

(51) Int. Cl. G21C 3/00

(52) U.S. Cl. 376/409

(57) ABSTRACT

Devices for generating heat and electric energy by nuclear fission reactions. The device includes a cylindrical tube, and a drain tube disposed inside having openings along its length for receiving drain fluid. The device also includes means forming the fuel layer disposed within the operative portion of the tube. The fuel layer generates fission products and has a thickness smaller than the fission product range. Drain fluid passes over the surfaces of the fuel layer, collects the fission products for discharge therefrom. The fuel hetero-structure is formed from the fuel layer, an insulating material and a liquid. The insulating material has a repetitive structure that includes at least three layers and interacts with the fission products to generate electricity. One of the layers generates electrons showers that are converted into heat or electricity.

### CROSS REFERENCE TO RELATED APPLICATIONS

This application claims the benefit of U.S. Provisional Application No. 60/748,489, filed on Dec. 7, 2005, which is hereby incorporated by reference in its entirety.

### BACKGROUND

During the past few decades, nuclear reactors have been developed as a solution to reduce the greenhouse effect due to burning of carbon-based fuels, such as coal, petroleum, natural gas and oil. Conventional nuclear fuel is generated by the process of sintering uranium dioxide (UO₂) powder into pellets. These pellets are covered by cladding material and form a reaction channel. In general, a nuclear reactor has a cooling system that surrounds each reaction channel and takes the fission-produced heat energy out. This heat energy is transferred through a series of heat exchangers to a turbine connected to an electro-mechanical generator, where the total exchange efficiency of a typical nuclear reactor is less than 40%.

FIG. 1 shows an exemplary plot of fission yield as a function of mass number for thermal fission of U-235. The horizontal axis represents the mass number of fission products, while the vertical axis indicates the abundance of the fission products. Typically, a thermal neutron with energy of ˜0.253 eV collides with a uranium-235 nucleus. Then, the compound uranium-236 nucleus splits in two median mass nuclei and typically releases 2 to 3 neutrons as well as energy. The released energy may total to around 203 MeV per disintegration: the kinetic energies of 167 MeV and 8 MeV of the fission products and neutrons, respectively, and prompt gamma emission energy of 8 MeV. As depicted in FIG. 1, the fission yield curve 10 in semi-logarithmic scale shows that the distribution of fission product abundance is symmetrical with respect to the median mass. Some of the most probable fission products are 90-Rubidium and 143-Cesium, and there are about 20 pairs of fission products that have mass numbers and yields close to the Ru—Ce pair. It is noted that the curve in FIG. 1 corresponds to the thermal neutron fission of 235U and not for other fissile materials like 239-Plutonium, 233-Uranium, 241-Americium, 252-Californium and other neutron energy.

FIG. 2A shows a plot of thermal conductivity versus temperature for conventional nuclear fuel: Uranium Dioxide (UO₂), Neptunium and Plutonium Dioxides (NPO₂ and PuO₂), Uranium Nitride (UN), Plutonium Nitride (PuN), and Neptunium Nitride (NpN). As depicted, the thermal conductivity of oxides is less than 10 w/(m ° K.), while those of nitrides range from 10 to 20 w/(m ° K.). The aspect and behavior of thermal conductivity of the oxides with increasing temperature are different from those of the nitrides.

FIG. 2B shows a schematic cross sectional diagram of a conventional cylindrical nuclear fuel pellet 202 after operation. As depicted, the nuclear fuel 202 includes a core 206 and a cladding layer 204, wherein the core 206 is made by sintering oxide powder. The core 206 includes central void 208 and three layers 210, 212, and 214. When installed for operation in a reactor, the core 206 has a uniform solid structure. However, as the operation time increases, the central portion of the fuel melts due to the heat energy and pressure generated by the fission products that accumulate in the fuel, making a void or cavity 208. The heat energy and pressure also cause cracks 216 to grow outward from the core, deteriorating the mechanical property of the core 206. In FIG. 2B, the core 206 is shown to have three layers: columnar grain growth layer 210, equiaxed grain growth layer 212, and original sintered structure layer 214. The temperatures at the outer edges of the void 208 and three layers 210, 212, and 214 are about 2000, 1800, 1500, and 800° C., respectively. To reduce the deterioration of mechanical property, the fuel can be fabricated with a cylindrical hole at the center. A disadvantage of this configuration comes from higher fabrication cost with lower reactivity, which may be partially compensated by higher reliability and longer life expectancy of the fuel.

FIG. 2C shows a temperature distribution 220 along a radial direction of the nuclear pellet 202 in FIG. 2B. As depicted, the temperature at the center of the pellet is about 80% of the melting point of the fuel. The temperature decreases as the radial distance from the center increases. The region 222 is filled with cooling fluid, such as water, that carries heat energy out of the reactor.

As depicted in FIG. 2C, the temperature at the center is set to be lower than the melting point of the ceramics, fuel oxide, but accidentally it may transit over for short time and the central void 208 is created. Typically, the temperature at the outer edge of the fuel 206 is much lower than that at the fuel center. Furthermore, the operation temperature of the cooling fluid is much lower than the fuel's melting temperature, which yields a low conversion efficiency (less than 50%). Based on the temperature profile and thermal properties of conventional fuel materials, it can be deduced that the central portion 224 of the fuel pellet 202 may be subject to higher expansion than the outer edge, inducing internal stress. The stress generates cracks in the brittle structure of ceramics. In addition, the fission products including solids and gases accumulate and precipitate in the fuel pellet 202, promoting the generation and propagation of cracks 216.

FIG. 2D shows an enlarged schematic diagram of a portion 213 in FIG. 2B, illustrating corrosions at the 206 fuel-cladding 204 interface and damages inflicted on the cladding layer 204. As depicted, cracks 230 may grow in the cladding layer 204. Also, local corrosion 232 may occur at the fuel-cladding interface. A cladding layer impaired by the cracks 230 and corrosion 232 may cause the fuel to be removed from the reactor core prematurely and stored in the reactor's waste fuel cooling pool. The fuel 206 may have a low burnup factor and a substantial amount of unburned fuel is radioactively contaminated by the presence of the fission products and immobilized. This effect contributes to the typical nuclear fuel cycle bottleneck.

As discussed above, the major damages to conventional fuel pellets during operation originate from the mismatch of temperature distribution 220 (FIG. 2C) in conjunction with poor thermal conductivities (FIG. 2A). In conventional reactors, it is required for the fuel pellet 202 to operate at high temperatures, near the melting point, in order to obtain a reasonable heat flow into the cooling fluid 222. Chemical diversity of the fission products makes the crack grow toward the cladding 204, limiting the cladding lifetime to no longer than 24 months. Fission products stopped in the fuel absorb neutrons to reduce the fuel reactivity, which typically needs to be compensated by adding extra fuel mass. Thus, there is a need for a new fuel structure that minimizes the fuel damage due to the thermal expansion and accumulated fission products.

To generate electricity, gas turbines operating at high gas temperature may be used. Alternatively, electricity can be harvested directly by use of a direct conversion method similar to the beta-voltaic method. The direct electricity generation, also called direct conversion method, has been developed since 1940. As reactors using the direct conversion technique are not heated by fission reaction and remain cold, even cryogenic, they can be used in various types of generators, such as mobile and/or modular power generators. The major difficulty in enhancing the operational efficiency of conventional direct conversion circuits stems from spatial incompatibility between the locations where the nuclear power is present and the conversion is performed. Thus, there is a need for a new conversion circuit that may reduce the spatial incompatibility and enhance the conversion efficiency.

### SUMMARY

According to one embodiment, a nuclear fuel assembly for a nuclear reactor includes: a generally cylindrical elongated tube having an inlet end and a closed opposite end defining an operative portion; a drain tube disposed within the elongated tube and extending from the inlet end through the operative portion to the closed end, the drain tube having openings along its length for receiving drain fluid; and means forming at least one fuel layer disposed within the operative portion of the elongated tube. The fuel layer is operative to generate fission products by fission reactions. Drain fluid caused to enter the operative portion through the inlet end passes over the surfaces of the fuel layer, captures the fission products and passes through the openings and thence along the drain tube for discharge therefrom.

According to another embodiment, a device for converting fission energy into electrical energy includes: a fuel layer for generating fission products by fission reactions; one or more CIci layer units stacked on the fuel layer, each CIci layer unit including a high electron density layer, a first insulating layer, a low electron density layer, and a second insulating layer; and an electrical circuit coupled to the high and low electron density layers and operative to harvest electrical energy. The fission products generate electron showers in the fuel layer and the high electron density layer while the low electron density layer absorbs the electron showers.

According to yet another embodiment, a tile for converting particle and radiation energy into electrical energy includes: a first layer including one or more CIci layer units, each CIci layer unit including a high electron density layer, a first insulating layer, a low electron density layer, and a second insulating layer, the first layer being operative to absorb a first portion of particles and radiations moving toward the surface thereof and to convert the energy of the first portion into electrical energy; a second layer formed over the first layer and including one or more CIci layer units and being operative to absorb a second portion of particles and radiations that have passed through the first layer and to convert the second portion into electrical energy; and a third layer formed over the second layer and including one or more CIci layer units and operative to capture neutrons that have passed through the first and second layers and to convert the energy of neutrons into electrical energy.

According to still another embodiment, a device for converting fusion energy into electrical energy includes: a chamber having a wall comprised of at least one CIci layer unit, the CIci layer unit including a high electron density layer, a first insulating layer, a low electron density layer, and a second insulating layer, the wall having at least two holes facing each other; two storage ring colliders for respectively sending fusion particle beams into the chamber through the two holes, the two beams traveling in directions opposite to each other; and means for focusing the two beams onto a collision spot in the chamber so that the two beams make fusion reactions at the spot. The wall absorbs fusion products generated by the fusion reactions and converts the energy of fusion products into electrical energy.

According to a further embodiment, a nuclear pellet includes: a generally cylindrical cladding layer; a metal grid covering a first transverse cross section of the cladding layer; a lower support covering a second transverse cross section of the cladding layer; and nuclear fuel grains filling a space bounded by the cladding layer, metal grid and lower support and capable of generating transmutation reactions. The liquid flows through the cladding layer and thereby washes the grains and carries recoils generated by the transmutation reactions.

### BRIEF DESCRIPTION OF THE DRAWINGS

FIG. 1 shows an exemplary plot of fission yield as a function of mass number for thermal fission of U-235.

FIG. 2a shows a plot of thermal conductivity versus temperature for conventional nuclear fuels.

FIG. 2B shows a schematic cross sectional diagram of a conventional cylindrical nuclear fuel pellet in operation.

FIG. 2C shows a temperature distribution along a radial direction of the nuclear pellet in FIG. 2B.

FIG. 2D shows an enlarged schematic diagram of a portion in FIG. 2B.

FIG. 3A shows a numerical simulation of Cs ion trajectories in a target.

FIG. 3B shows a plot of energy deposition in the fuel lattice by ionization and collisions of Cs ions with the lattice's nuclei.

FIG. 4A shows numerically simulated trajectories of ions injected into a bi-material target.

FIG. 4B shows a distribution of density of stopping ions in a bi-material target.

FIG. 4C shows a distribution of recoil energy deposited in a bi-material target.

FIG. 4D shows a distribution of phonon energy deposited in a bi-material target.

FIG. 5 shows how to determine fuel thickness or dimension in accordance with one embodiment of the present invention.

FIG. 6 is a schematic cross sectional diagram of an embodiment of nuclear fuel in accordance with the present invention.

FIG. 7 is a schematic cross sectional diagram of another embodiment of fuel in accordance with the present invention.

FIG. 8 is a top view of yet another embodiment of fuel having a web structure in accordance with the present invention.

FIG. 9 is a schematic perspective view of still another embodiment of fuel having a meshed felt structure in accordance with the present invention.

FIG. 10A is a schematic diagram of an embodiment of a fuel tube in accordance with the present invention.

FIG. 10B is a schematic diagram of another embodiment of a fuel tube in accordance with the present invention.

FIG. 11A is a schematic diagram of yet another embodiment of a fuel tube in accordance with the present invention.

FIG. 11B is a schematic cross sectional view of fuel contained in the fuel tube in FIG. 11A.

FIG. 12A is a schematic cross sectional diagram of still another embodiment of a fuel tube in accordance with the present invention.

FIGS. 12B-12E are enlarged schematic diagrams of various portions of the fuel tube in FIG. 12A.

FIGS. 13A and 13B are respectively schematic transverse and longitudinal cross sectional diagrams of an embodiment of a reactor channel module in accordance with the present invention.

FIG. 14 shows a plot of a volumetric dilution factor as a function of a volumetric parameter.

FIG. 15 shows a plot of effective thermal conductivity of various fuel types.

FIG. 16 is a schematic cross sectional diagram of an embodiment of a nuclear reactor in accordance with the present invention.

FIG. 17 shows a schematic diagram of one embodiment of a nuclear power plant in accordance with the present invention.

FIG. 18A shows a plot of exemplary trajectories of fission products penetrating a multi-materials thin target.

FIG. 18B shows a plot of energy deposition by ionization in the target of FIG. 18A.

FIGS. 18C and 18D respectively show plots of phonon energy and recoil energy in the target of FIG. 18A.

FIG. 19 shows a schematic diagram of an embodiment of a device for direct conversion of fission-fusion energy into electrical energy in accordance with the present invention.

FIG. 20 shows a schematic cross sectional diagram of another embodiment of a device for direct conversion of fission energy into electrical energy in accordance with the present invention.

FIG. 21 shows a schematic cross sectional diagram of yet another embodiment of a device for direct conversion of fission energy into electrical energy in accordance with the present invention.

FIG. 22A is a schematic cross sectional diagram of still another embodiment of a device for direct conversion of fission energy into electrical energy in accordance with the present invention.

FIG. 22B is an enlarged schematic cross sectional view of a voxel in FIG. 22A

FIG. 23A is a schematic cross sectional diagram of a further embodiment of a device for direct conversion of fission energy into electrical energy in accordance with the present invention.

FIG. 23B is a schematic cross sectional diagram of another further embodiment of a device for direct conversion of fission energy into electrical energy in accordance with the present invention.

FIG. 24 is a schematic diagram of yet further embodiment of a device for direct conversion of fission energy into electrical energy in accordance with the present invention.

FIG. 25 is a schematic diagram of another embodiment of a device for direct conversion of fission-fusion energy into electrical energy in accordance with the present invention.

FIG. 26 is a schematic diagram of an embodiment of a nuclear power plant in accordance with the present invention.

FIG. 27 is a schematic cross sectional diagram of an embodiment of a tile for harvesting fission/fusion/cosmic ray energy in accordance with the present invention.

FIG. 28A shows a schematic diagram of another embodiment of a tile for harvesting fission/fusion/incident beam/cosmic ray energy in accordance with the present invention.

FIG. 28B shows an enlarged schematic diagram of a portion of the tile in FIG. 28A.

FIG. 29 shows a schematic diagram of an embodiment of a device for fusion energy harvesting and ion beam propulsion in accordance with the present invention.

FIG. 30 shows a schematic diagram of a space vehicle having the tile in FIG. 28A and the device in FIG. 29 in accordance with the present invention.

FIG. 31 shows a schematic diagram of an embodiment of a device for cosmic wind energy harvesting in accordance with the present invention.

FIG. 32A shows a plot of exemplary trajectories of recoil products escaping from a target.

FIG. 32B shows a plot of recoil ion ranges in the target of FIG. 32A.

FIG. 33 shows a cross sectional view of nano-sized grains immersed in collector liquid in accordance with one embodiment of the present invention.

FIG. 34A shows an embodiment of a nano-hetero nuclear pellet in accordance with the present invention.

FIG. 34B is a schematic enlarged view of a portion of the pellet in FIG. 34A.

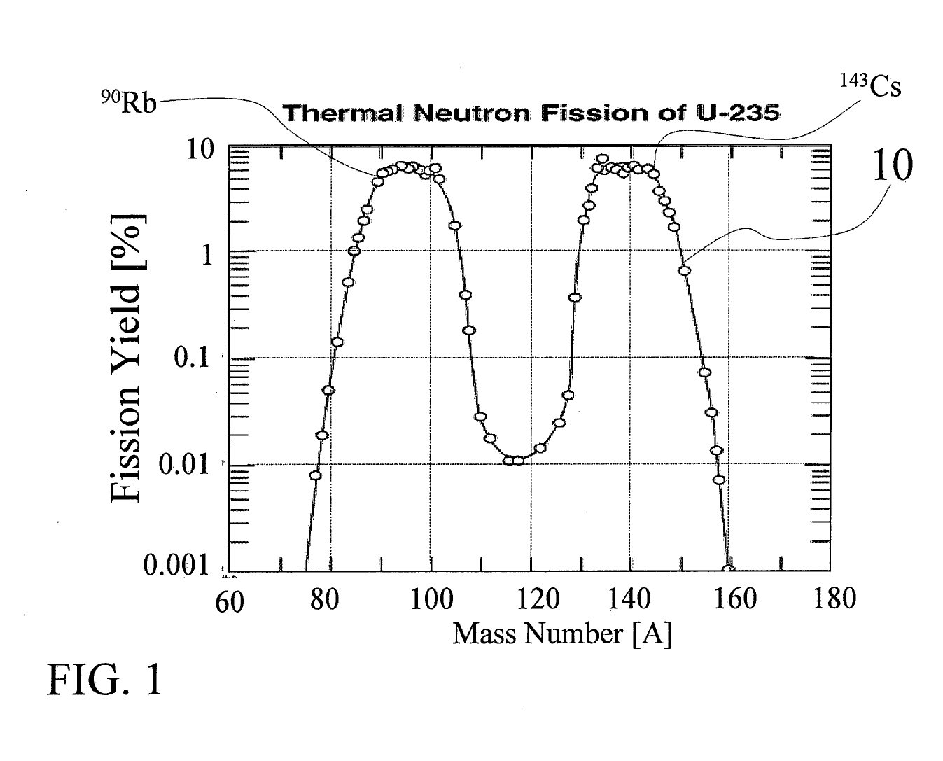

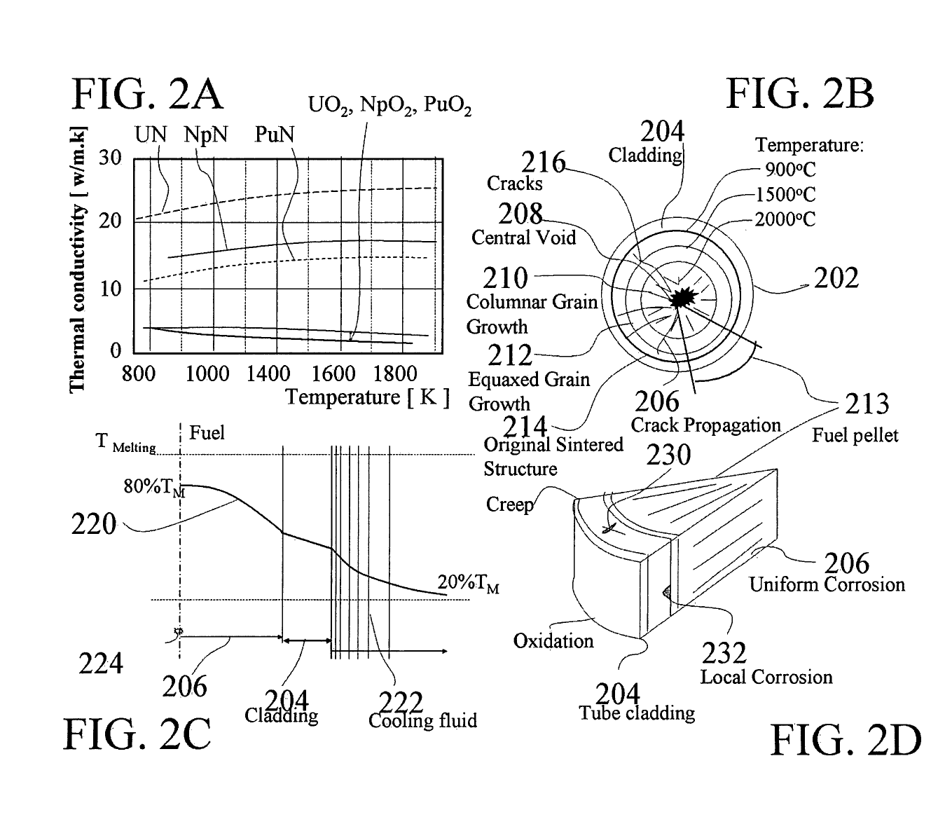

### DETAILED DESCRIPTION

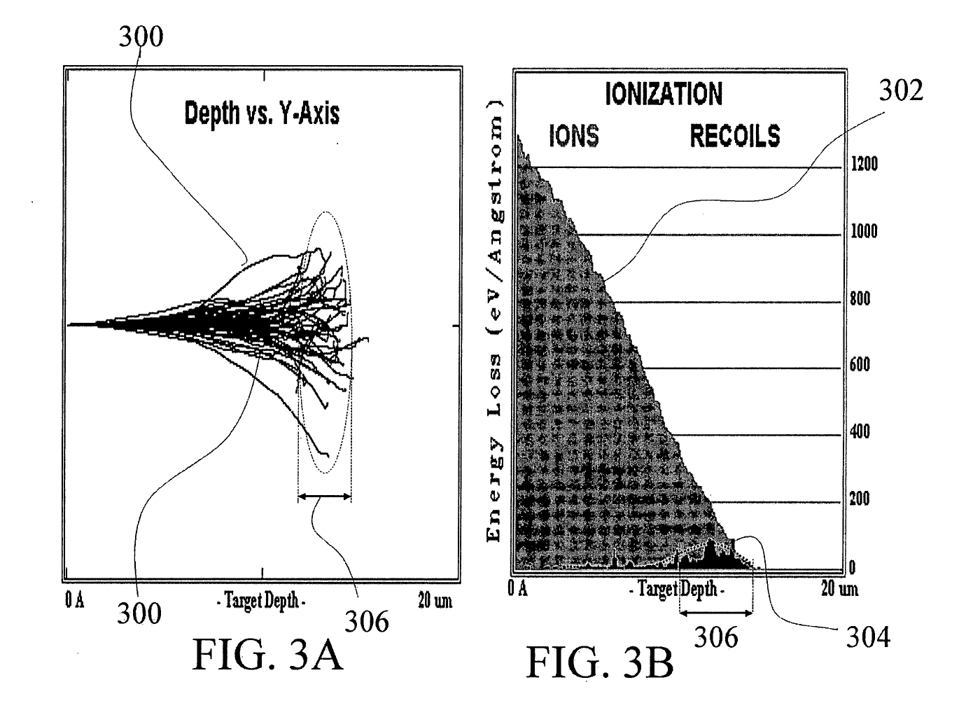

FIG. 3A shows a numerical simulation of Cs ion trajectories 300 in a target, wherein the Cs ions are injected into nuclear fuel target formed of uranium dioxide (or, shortly urania) with 100% compaction (no porosity). The simulation is performed by use of the conventional Simulations of Reactions of Ions with Matter (SRIM) software. It can be noticed that most of the Cs ions decelerate to rest in about 14-15 micrometers 306 from the target surface while the lateral straggling ranges about 3-4 microns. It is noted that these dimensions are material, material structure and ion type and energy dependent.

FIG. 3B shows a plot of energy deposition in the fuel lattice by ionization and collisions of Cs ions with the lattice's nuclei, called recoil. A numerical simulation is performed to obtain the curves 302 and 304. The curve 302 represents the ionization energy deposited by Cs ions with an entry kinetic energy of 100 MeV as a function of distance from the target surface. The dotted curve 304 represents an envelope of the nuclear recoil energy distribution. As depicted, the curve 304 has a peak in the region 306 between about 10 microns from the target surface and the end of ion penetration. As such, the maximum nuclear recoil damage takes place in the region 306. The chemical properties and reactivity of Cs ions, typical fission products, enters into force at about 12 microns from the fuel surface, i.e., Cs ions strongly interact with urania in the weakest zone, like inter-grains boundaries, of the fuel. The recoil damage may be reduced if the fuel dimension is slightly less (say 5%) than the distance between the surface of the fuel and the onset of the region 306.

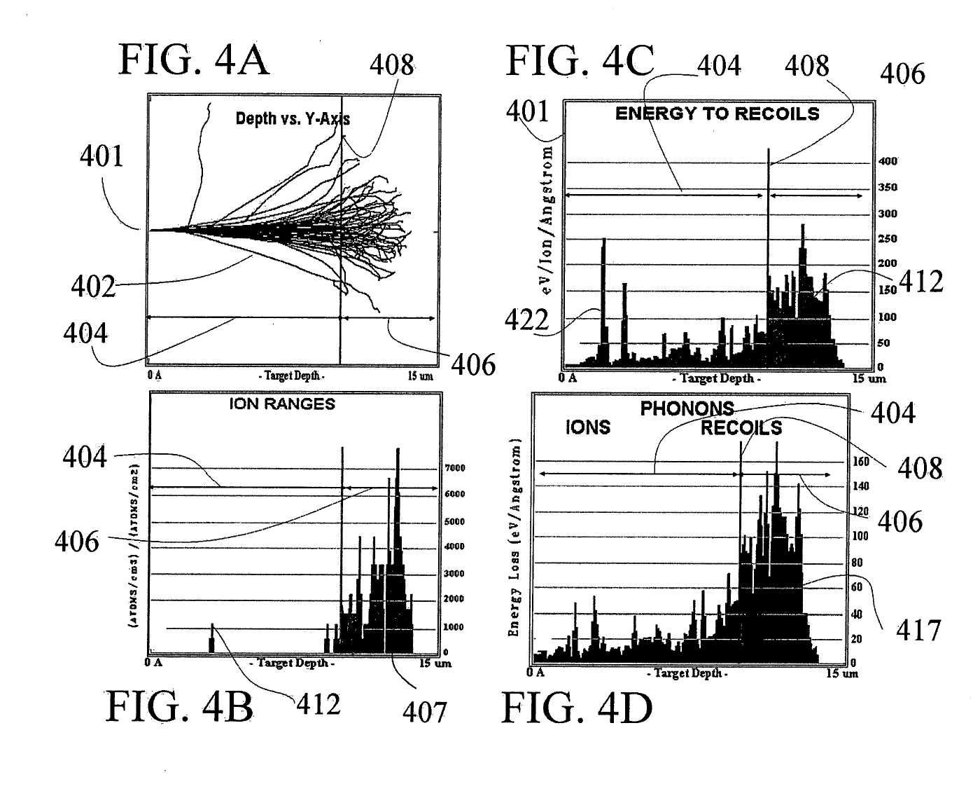

FIGS. 4A-4D show numerical simulations of various quantities associated with Cs ions injected into a bi-material target having urania and lead-bismuth eutectic (LBE) liquid. FIG. 4A shows numerically simulated trajectories 402 of ions injected into a bi-material target including urania 404 and lead-bismuth eutectic (LBE) liquid 406, wherein the thicknesses of the urania and LBE liquid are 10 microns and 5 microns, respectively. The line 408 represents the boundary between the urania 404 and LBE liquid 406, where the horizontal axis represents the distance from the urania surface. As depicted, most of the fission products decelerate to rest in LBE 406. Being a liquid, the LBE 406 may not be affected by nuclear recoil damages that, in solid lattices, may induce stress and grain fragmentation. LBE liquid 406 has also a higher thermal conductivity than urania 402, which makes the fuel remain at lower temperature.

FIG. 4B shows a distribution of density of stopping [in the unit of atoms/cm²] as a function of distance from the urania surface. Except few atoms 412 having nuclear collisions, most of the ions pass through the urania 404 and interface 408 and stop in the LBE liquid 406. The average penetration distance for this case is about 14 μm, with a straggling width of +/−1 μm. The quantitative value of the stopping density 407 is shown on the lateral scale.

FIG. 4C shows a distribution of recoil energy deposited in a bi-material target by Cs ions injected with 100 MeV entry energy. As depicted, the deposited recoil energy 422 shows a peak at the location 412 (shown in FIG. 4B) where nuclear collisions occur. Also, the deposited recoil energy becomes significant in the region where the distance from the fuel surface 401 exceeds 12 microns.

FIG. 4D shows a distribution of phonon energy (or, shortly phonons) deposited in a bi-material target, where the phonons are quasi-particles associated with temperature and heating. In general, the energy deposited in phonons is about ⅓ of the deposited recoil energy shown in FIG. 4C. The distribution 417 of phonon energy is similar to that of recoil energy in FIG. 4C, with a slight difference that this energy is deposited immediately before the particles come to rest in LBE liquid 406 and is smaller in urania 402 and interface 408. That means that a small portion of the outer crust of the particles adjacent the interface 408 is heated more than the central portion of the urania 402 but less than the surrounding LBE liquid 406, which drives mainly to a uniform temperature distribution inside the urania 402 and reduces the high stress present in conventional fuel pellets. It is important to observe that the most of the heat is deposited outside of the fuel bead in a better conductive material that is the liquid metal.

The bi-material fuel may be made from other suitable pairs of materials insofar as the pairs have the similar characteristics as discussed in conjunction with FIGS. 3A-4D. In general, the first material 402 may be called “generator” because it is the source of the fission products, while the second material 404 may be called “absorber” as it stops and absorbs the generated fission products. To resolve chemical incompatibility and material adhesion issues, a supplementary interface, called “insulator,” may be interposed between the generator and absorber.

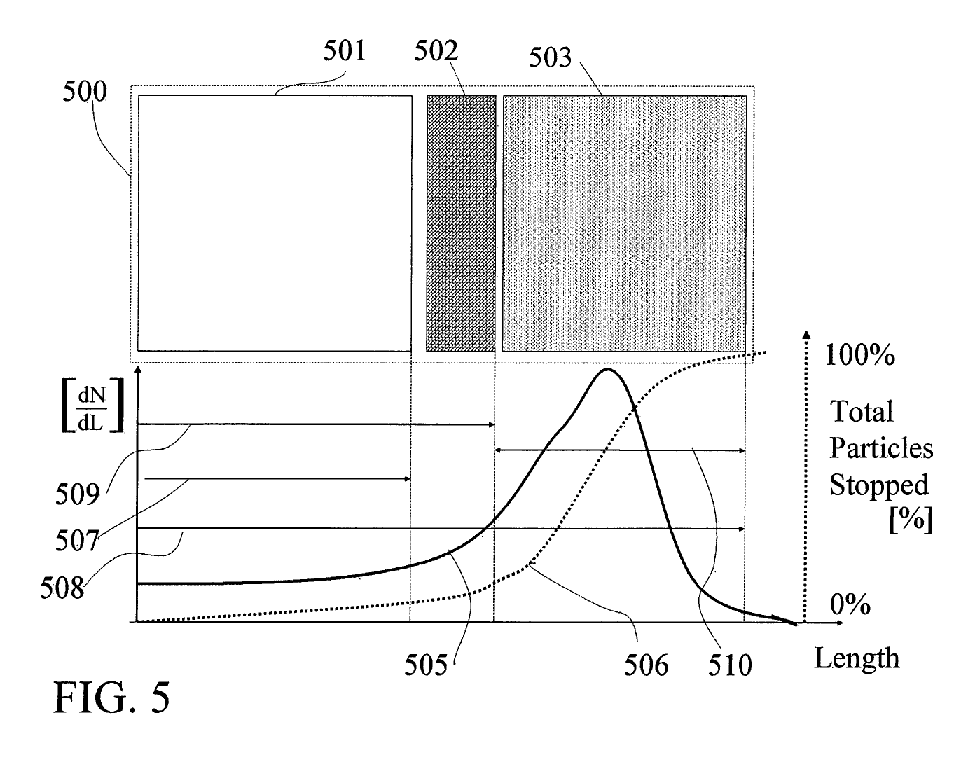

FIG. 5 shows how to determine fuel thickness or dimension in accordance with one embodiment of the present invention. As depicted, the approach described with reference to FIG. 5 is based on an exemplary assembly 500 having three layers or components, generator 501, insulator 502, and absorber 503, wherein each component has a generic functionality. The assembly may form an elemental module that can be stacked repeatedly in certain applications. The “generator” 501 is formed of material that can generate the particles of interest, such as fission products, knock-on electrons, or recoils. In practice, the generator 501 is formed of alloys or mixtures containing fissile material, such as Uranium, Plutonium, Neptunium, Americium, Californium, or other actinides. The generator 501 can be also formed of liquid material. A knock-on electron(s) is generated by an electromagnetic collision of a moving entity, such as fission product, ion, electron, radiation, neutral atom or molecule with a material lattice, wherein the material has preferably high electron density. For recoils, the end of range takes place pulling out the recoiled particles from the generating material like depleted uranium, etc. nano grains into the collector material.

The insulator 502 operates as an electrical, a chemical, or a molecular separator for separating the generator 501 from the absorber 503 and is associated with either the generator 501 or the absorber 503. The insulator 502 may be in the form of a layer, molecules, or clusters. The insulator 502 assures the separation properties enhancing the material interface properties by faceting or coating. In the case where both the generator 501 and absorber 503 are liquids, the insulator 502 may be used to provide the mechanical stability. The insulator 502 is invisible to the moving entities, such as fission products, electrons, recoils and other particles including molecules, ions, photons (X, gamma), and cosmic rays.

The absorber 503 is formed of a material, a material compound, chemical combinations, or alloys and is designed to stop the particles produced by the generator 501. For the fission products, knock-on electrons, and recoils, the absorber 503 functions as a stopping device and its material is mainly selected based on the capability of performing the deceleration process without major structural and chemical changes in time. The materials may be liquids, liquid metals, salts, solids, or gases. For the knock-on electrons, the absorber material is selected such that the absorber is able to stop the electrons without generating other electrons in interaction with the generator agent. The material may be conductor or superconductor with low electronic emissivity. Preferably, the material has low electronic density and is in the form of solid, liquid, or plasma. Conventional low-electron density materials may be included in the absorber 503. For recoils, the absorber 503 is formed of material that has different chemical properties than the recoils and stabilizes the recoils so as to make them easy to collect, concentrate, and separate from the absorber material.

Upon selection of materials for the three components 501, 502, 503, a linear dimension, called “effective length” can be defined by weighting the effects of interest, wherein the effects of interest occurs within the effective length. In the case of generator 501, the generated objects are not self-absorbed within a reasonable range, “effective length of the generator (EfLG) 507,” with or without the maximization of the desired phenomenon: “the generation”. The curve 505 represents the number of absorbed particle per unit length. As can be noticed, the generator 501 absorbs a small fraction of particles. As such, in practice, EflG 507 is determined considering the self-absorption of particles as well as other technological conditions, such as maximization of generation, mechanical stability, chemical stability, self-repairing, clusterization, etc. In the case of the absorber 503, the desired phenomenon is the maximization of the absorption of the product generated by the generator 501 with the optimization of other effects, such as minimization of the production of particles, maximization of stability, minimization of structural damage, maximization of current transport, heat, particles, etc. The curve 506 represents the total number of particles stopped as a function of distance from a surface of the generator 501. The effective length of the absorber (EfAL) 510 represents a characteristic length for producing absorption to a desired extent. Due to the fact that calculations are performed considering the whole assembly of materials, EfAL 510 of the absorber 503 becomes the difference between the absorption effective length EfLA 508 and EfLG 507 and the insulator thickness EfGI 509, truncated at a technological value. The technological value refers to a dimension that can be technologically obtained and is stable in time.

In practice, the optimization is performed considering a sequence of optimization conditions and the effective lengths are calculated iteratively. The effective lengths are, in the case of fission products, in the micrometric domain while, in the case of electrons and recoils, the effective lengths are in the nanometric domain. In the case where both fission products and electrons/recoils are considered simultaneously, the effective lengths are in the nano-micro domain and a hybrid structure is obtained.

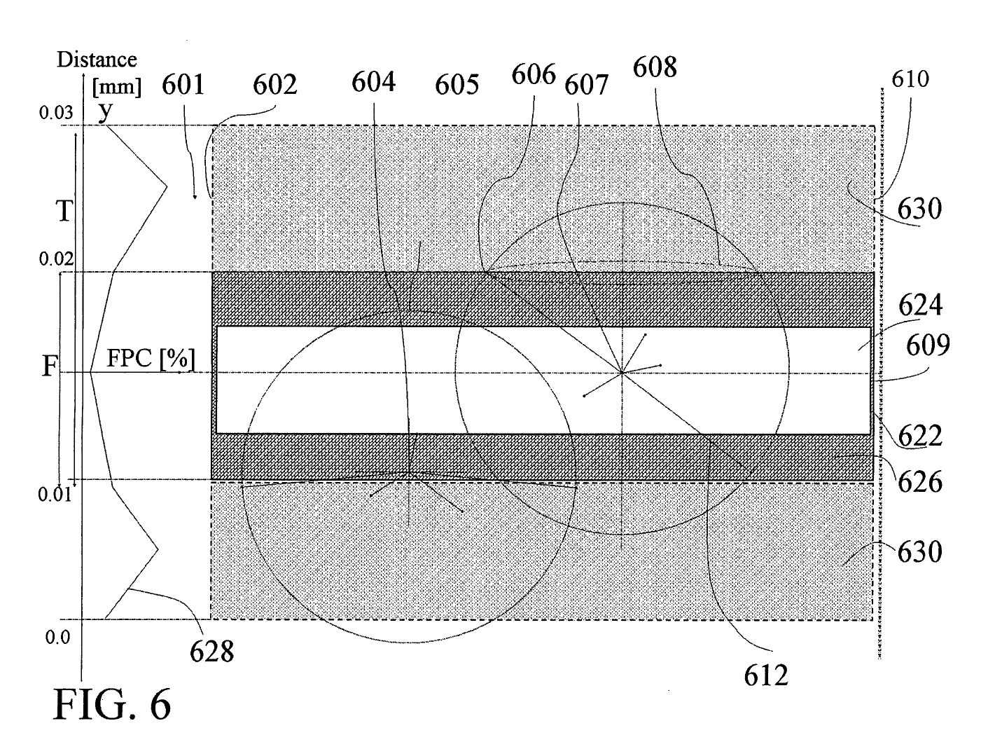

FIG. 6 is a schematic cross sectional diagram of an embodiment of nuclear fuel in accordance with the present invention. As depicted, the fuel 622 is surrounded by drain liquid 630 and includes two layers: a core 624 made of nuclear fuel and an insulating layer 626. For brevity, only one fuel layer 622 and two drain liquid layers 630 are shown in FIG. 6, even though the overall fuel assembly includes alternating strata of fuel and drain liquid layers. The effective lengths have been calculated in the ordinate (y) direction only, i.e., the thicknesses of the fuel 622 and the drain liquid 630 in the y-direction have been calculated. The core or middle portion 624 is formed of metallic material or chemical compositions, such as N-Nitride or C-Carbide, while the insulating layer 626 is formed of a large variety of materials including metals, Ti, W, Graphite, carbides, oxides, fulerens, other pili-structures. The heterogeneous structure of the fuel 622 may be achieved by electro-deposition technique, or molecular vapor deposition technique based on plasma spray, or a combination of molecular beam technique and selective reaction accelerator assisted deposition technique. Methods like chemical vapor deposition with various chemical reaction initiations may be used to achieve a high productivity. The simplest fabrication method may be chemical electro-deposition in adjacent baths, creating a closed loop tape or an endless tape (Mollus tape) that is drawn through the electro-deposition baths, until it reaches a critical dimension. To assure stability, the borders of the tape can be channeled and coupled to cladding material. The drain fluid layers 630 can be deposited with the fuel layers 622 because at the deposition temperature, the drain liquid may be in the form of solid. Any conventional fissile material, such as Th, U, Pu, Np, Am, and Cf, may be used as fuel 622. The isotopic enrichment factor may play an important role in determining the thickness ratio of layers so as to meet the criticality conditions for a given reactor structure.

The drain fluid 630 is a liquid metal that does not chemically interact with the fuel 622. There are several materials for the drain liquid, such as Na, K, NaK, Al, Zr, ZrNb, Pb, Bi, PbBi, etc. The type of drain liquid determines the temperature range where the reactor operates. The exact calculations for a nuclear reactor application require the knowledge of the neutron properties in all materials, material purity, mixing ratios, shapes, etc. for reaching the criticality in the reactor structure.

The insulating layer 626 increases the passivity of the fuel towards the drain liquid 630, allows the operational temperature to increase, and also reduces the rim effect due to the burnup. For structural reasons, the fuel 622 is tightly secured to lateral supports, such as cladding, i.e., both sides 601, 609 of the core 624 as well as the porous walls 602 and 610 are secured to the lateral supports (not shown in FIG. 6). During operation, one lateral support facing the porous wall 602 provides drain liquid through the wall 602, while the contaminated drain liquid is drained through the porous wall 610 into another lateral support facing the porous wall 610. If this structure is built in a large scale, the drain liquid 630 has a tendency to inflate the surface and shear. That is why bounding fuel or structural filaments are drawn vertically in the fuel, interconnecting the layers of fuel, in a similar way the lateral cladding is drawn. This can be achieved by masking procedures or by using mili/micro-beam accelerators to build the fuel micro-wires.

During the operation of the reactor, the fission reaction occurs in various locations 604, 607, for instance. The spheres 605, 606 represent the ranges that fission products can travel through the fuel 622 and drain liquid 630. The radii of the spheres 605, 606 depend on the material type, concentrations, type and energy of fission product, etc. The fission product paths, which are represented by arrows 612, depend on the energy and pulse conservation at the fission point 607. The stopping process takes about few pico-seconds, and at the end of the range, some other type of energy release may happen (like beta disintegration of the fission product, being accompanied by neutrino and gamma release).

The dimension of fuel 622 in the y-direction is shorter than the stopping range so that most of the heat, lattice damage, and beta release occur in the drain liquid 630. Assuming that the fuel and drain liquid have a same stopping power and the distribution of the range locus has a spherical shape (605, 606), it is found that only a portion of the fission products flying within the solid angle 608 can escape the fuel 622 and decelerate to rest in the liquid 630. So the drain efficiency of the planar structure is about 50%.

A plot 628 represents a distribution of the predicted fission product concentration in an arbitrary unit (horizontal axis) along the vertical axis. The F, T letters denominate the fuel thickness and the total thickness of a pair of fuel-drain liquid layers, respectively. The thickness of the fuel is set to about 80-90% of the particle range in the fuel, where the range is about 14 microns for conventional urania fuel. The stopping in PbBi (LBE—Lead Bismuth Eutectic) drain liquid is even harder. So, as an example, a modulus of 10-10 microns of Urania-LBE may be used in the fuel assembly shown in FIG. 6.

The fuel may be fabricated by selective excitation vapor deposition in one of the following shapes: 1) planar shape of a condenser structure with vertical stability connections, and 2) conical shape when the object is tilted and spins. The fuel structure may be: 1) low temperature structure when the fuel is made from metallic compounds like U—Pb; Pu—Ga/PbBi, AmU/Pb, 2) medium temperature structure when the fuel is made from Urania, Thoria, Plutonia in tungsten lattices and the LBE drain fluid is encapsulated in stainless steel cladding for NaK or LBE cooling, or 3) high temperature structure when the fuel is made from ceramics of UCWTi and self sustained in a WCTi cladding with Zircalloy drain liquid and He cooling.

For the reactor fuel channel design, the positions and directions of the fuel structure need to be considered. As an example, for LBE drain liquid, due to high static pressures, a horizontal and low tilted structure or a short structure is recommended, while for NaK drain liquid, orientation may not be important because the static pressure drop is relatively small.

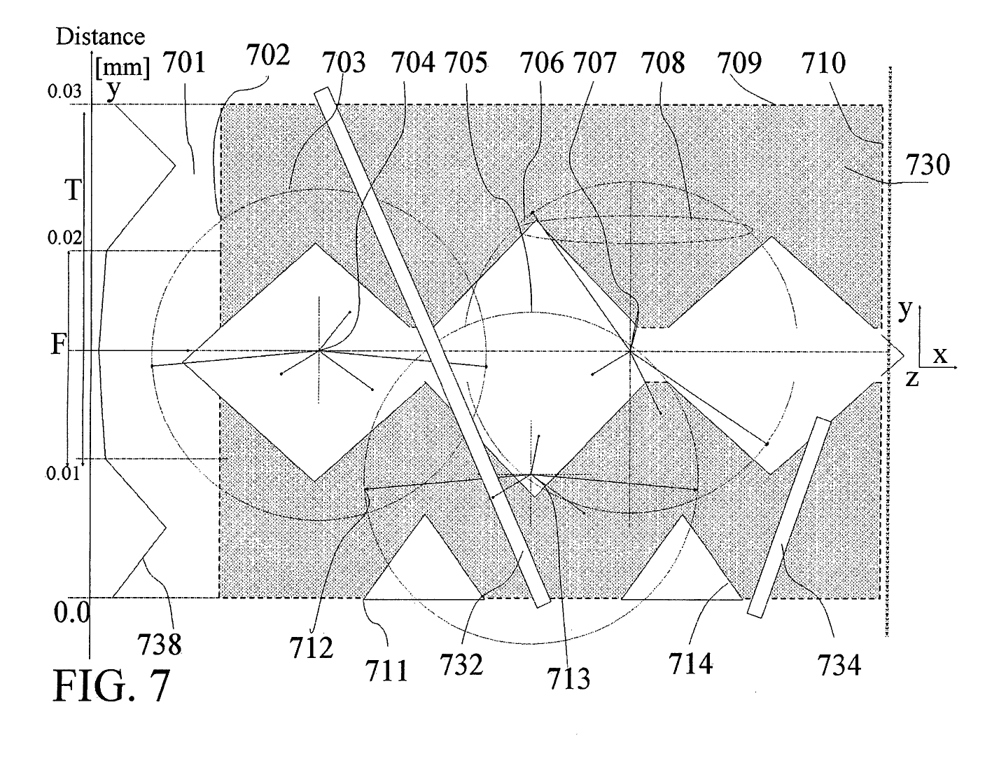

FIG. 7 is a schematic cross sectional diagram 709 of another embodiment of fuel having a bi-dimensional structure in accordance with the present invention. To enhance the fission product escape angle (608 in FIG. 6) and thereby to increase the drain efficiency and mechanical stability of the solid fuel lamella, the fuel 701 has a varying thickness and includes prism-shape portions. The fuel 701 may be generated by controlled plasma spray technique, CVD technique using masks, or heterogeneous electric field electrochemical bath deposition. The effective length principium in FIG. 5 has been applied twice to determine the dimensions in the x and y directions.

As depicted in FIG. 7, the fuel lamella has a profile of connected prisms along the z axes to enhance mechanical strength and escape angle. The effective escape angle of the fuel 701 may exceed 70% of the total solid angle and more than 80% of the fuel fission products are released into drain fluid 730 surrounding the fuel 701. The spheres 703, 705, 706 represent the penetration ranges of fission products 712 generated at locations 704, 707, and 713. Assuming the fuel 701 and drain liquid 730 have a same stopping power, the escape angle 708 is significantly greater than that of the fuel 622 in FIG. 6. The dimensions of the fuel and drain liquid determine the stopping power and ranges, and, as a consequence, the escape factor, wherein the escape factor is the number of the fission products stopping outside the fuel per the total number of fission. The stiffness of the fuel 701 increases by using random vertical connection interfaces 732, 734 between the layers 701 and 714 and channeled or porous cladding connection 702, 710.

The fuel 701 may be manufactured by controlled vapor deposition of solid drain fuel on micromeshes, then by annealing and compressing the drain fuel to be removed or by electro-deposition of metallic structures. For high temperature reactors, tungsten or titan carbide based structures may be used. The fuel 701 may be formed of a mixture of metal and carbides with structural material. As in the case of FIG. 6, the drain fluid 730 may pass through the porous walls 702 and 710. A plot 738 represents a distribution of the predicted fission product concentration in an arbitrary unit (x axis) along the y axis.

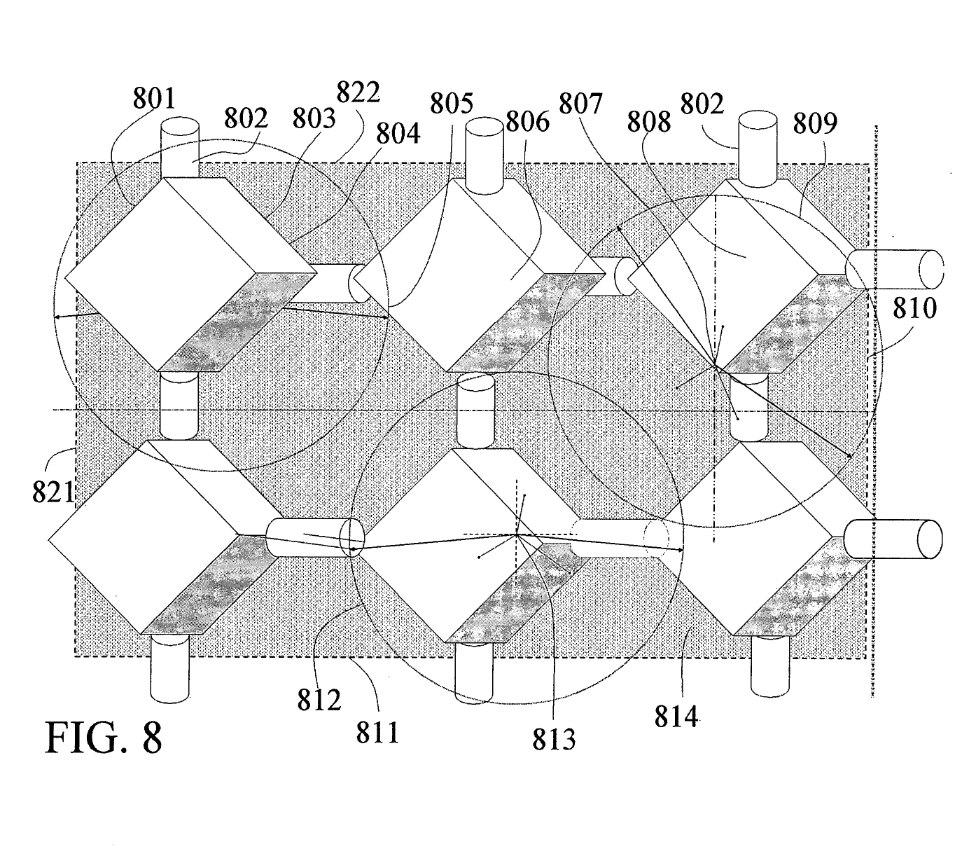

FIG. 8 is a top view of yet another embodiment of fuel having a web structure in accordance with the present invention. As depicted, the fissionable fuel grains or beads 801, 806, 808 are connected by meshes 802. The meshes or filaments 802 are made of tungsten, titanium, steel, etc. and have a thickness in the micron range and are spaced apart from each other by about 20-50 microns. The fuel beads 801, 806, 808 are placed on the mesh knots. The beads may be fabricated by hot molding or by vapor deposition of fissile material, such as urania, metal uranium, and plutonium, or carbides or nitrides of the fissile material. To stabilize the meshes, micro-beam electron welding may be used.

The fuel has vertical stabilization points 810 to prevent the webs from skidding under the flow of the drain fluid 814. The drain fluid 814 may pass through the porous walls 810, 811, 821. In this structure, the escape factor is increased up to 90%, but is strictly dependent on the dimensions of the fuel and meshes. For diluted fuels made from high-enriched uranium (HEU), plutonium, or americium, and embedded in the drain fluid, the escape efficiency may increase up to 99%.

The tungsten mesh stand up to 3200° C. and, if the fuel beads are chemically coated by C implantation or carbon plasma discharge, the entire structure may stand over 2000° C. The fission products are generated at locations 804, 807, 813 and their penetration ranges are represented by spheres 805, 809, 812, wherein the spheres mainly end in the drain fluid 814. The interface 803 between the fuel bead 801 and the drain liquid 814 increases the structural stability. It is noted that only six beads are shown in FIG. 8. However, it should be apparent to those of ordinary skill that any suitable number of beads may be surrounded by the porous walls 810, 811, 821, 822.

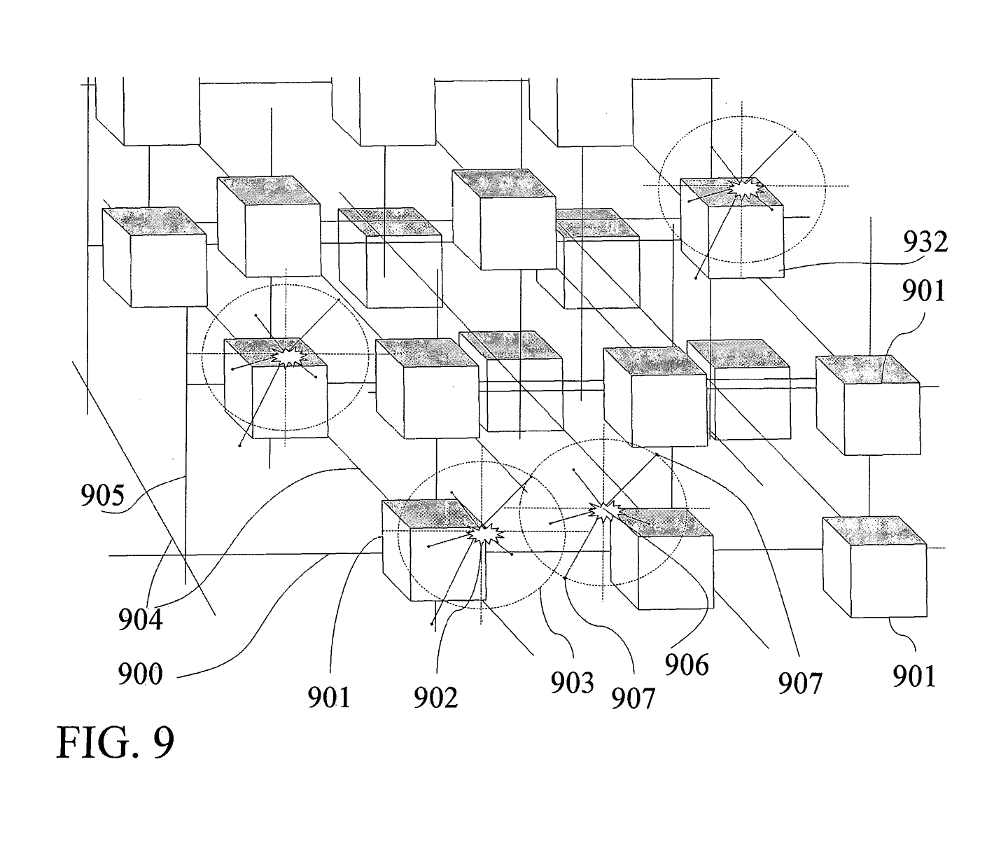

FIG. 9 is a schematic perspective view of still another embodiment of fuel layer having a meshed felt structure in accordance with the present invention. As depicted, the fuel structure in FIG. 9 is quite similar to that of FIG. 8, with the difference that a denser network of wires 900, 904, 905 is used in place of the vertical structural fixture of webs in FIG. 8, creating a highly resistant felt structure. The 3D structural wires or meshes may be created by chemical vapor deposition, or by plasma spray deposition, connecting each 2D web mesh to a third wire 905, wherein the fuel beads 901 are located on the knots of the 2D web mesh formed by wires 900, 904.

During operation, the fission act occurs in various locations 902, 906 and the fuel nucleus splits generating 2-4 neutrons and two middle mass fission nuclei 907 that travel through the fuel into the drain fluid 932. The fission products decelerate to stop at the end of the penetration range, creating loci or spheres of probabilities 903. When stopped by the drain liquid 932, a fission product produces a regional dislocation to generate a micro pressure shock wave, and may or may not react with the drain liquid to create a suspension. The fuel to drain liquid interface needs to be specially treated to prevent the suspension from clogging. The prevention may be obtained by deposition of delta layers that create a compact structure in the fuel. An example is the action of Gd in Pu lattices. PuC or PuGdC coated with a gold delta layer repels the fission products towards the drain liquid. The fuel structure shown in FIG. 9 is flexible and stable under irradiation.

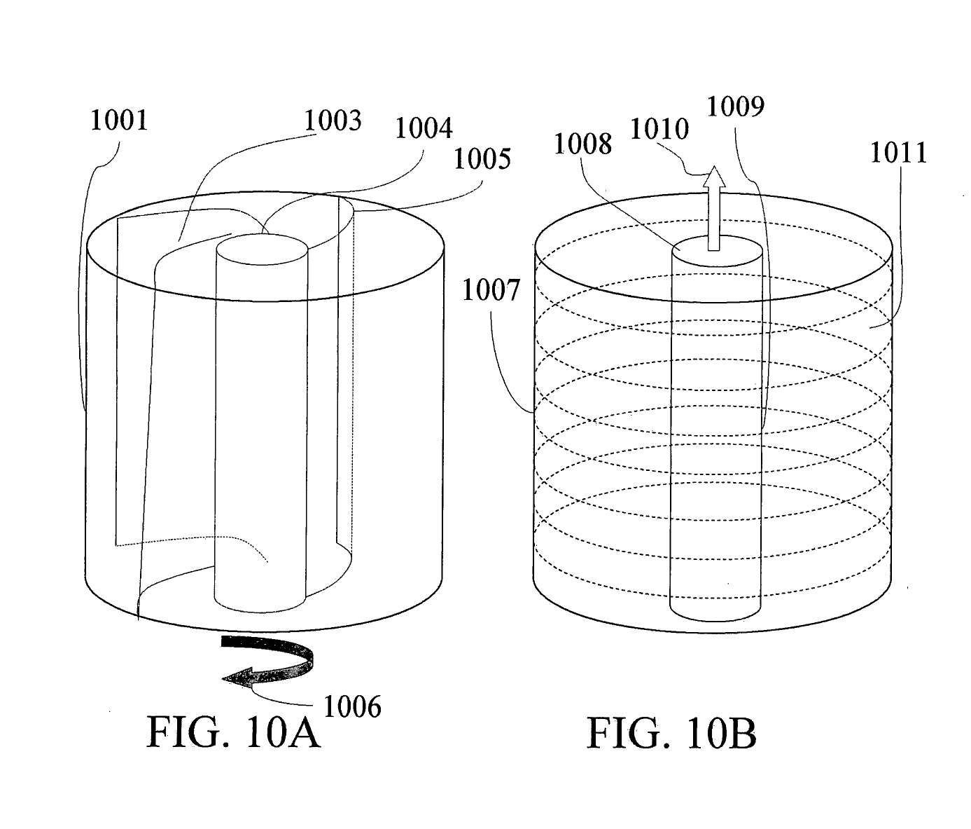

FIG. 10A is a schematic diagram of an embodiment of a fuel tube in accordance with the present invention. As depicted, the fuel 1005 has a shape of curved plate 1005 aligned along the longitudinal axis of a drain tube 1004, wherein the fuel 1005 and drain liquid 1003 are contained in a cladding tube 1001. The drain fluid 1003 passes through the porous wall of the drain tube 1004. To compress the structure, the drain tube 1004 and fuel 1005 may be rotated in the direction 1006. The fuel 1005 has one of the structures described in FIGS. 6-9.

FIG. 10B is a schematic diagram of another embodiment of a fuel tube in accordance with the present invention. As depicted, the fuel has a shape of multiple circular disks 1011 that are stacked along a drain tube 1008, where the fuel 1011 and drain tube 1008 are contained in a cladding tube 1007. The drain tube 1008 has a porous side wall 1009, through which the drain fluid passes through. Then, the drain fluid flows along the drain tube in the axial direction 1010. It is noted that the present invention may be practiced with other suitable number and form of disks. For example, funnel-shaped disks may be used in place of the circular disks 1011. The fuel 1010 has one of the structures described in FIGS. 6-9.

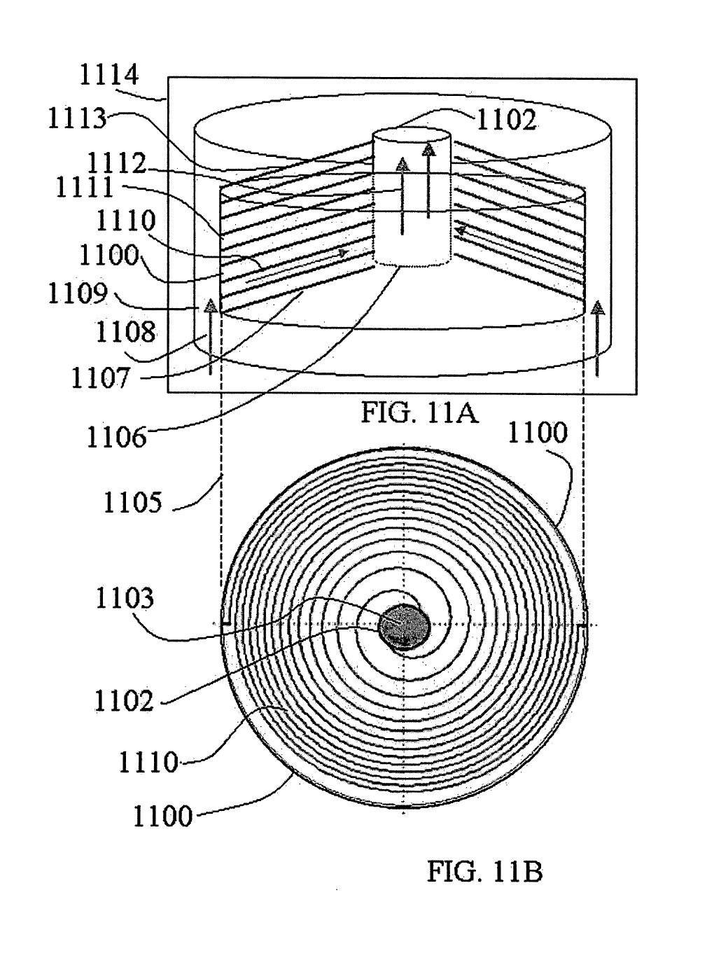

FIG. 11A is a schematic diagram of yet another embodiment of a fuel tube in accordance with the present invention. FIG. 11B is a schematic cross sectional diagram of the conical fuel disks 1110 taken along the line 1111 in FIG. 11A. As depicted, fuel is embedded in the disks in a spiral mesh form. The multiple conical disks 1110 are contained within a pellet porous tube 1100. Each fuel disk is shaped like a funnel, creating a helical surface inside. Also, by moving the radial levers 1107, 1113 in the vertical direction, the fuel disks 1110 can be compressed within the pellet tube 1100 in order to vary its reactivity and to compensate for the loss of fuel and poison accumulation effect due to the burnup. The fuel disks 1110 are tightly bound to the pellet porous tube 1100 and the central porous tube 1102. The central tube or drain tube 1102 is used for draining out drain fluid 1103 that contains fission products. The drain liquid 1103 comes from an equipment located outside the external fuel tube case 1114, enters the outer tube channeling 1109 in the vertical direction 1108, flows along the space between the fuel disks 1110 to collect fission products, passes through the porous wall of the central tube 1102, and flows along the fuel tube in the direction 1112 to exit the case 1114, and is sent to a separation unit that is located outside the reactor. In the separation unit, the drain liquid is cleaned up and recycled, while the fission products are separated.

The radial levers 1107, 1113 are attached to and actuated by external levels 1105. From the mechanical point of view, the radial levers 1107, 1113 form discontinuous surfaces and anchor the fuel disks 1110 to allow radial diameter modification, cone angle sharpening and twisting the disks into helical shapes, thereby to assure the maximum fuel compression with minimal friction between the wall of the pellet tube 1100 and the external lever 1105 and radial levers 1107, 1113. There are other compressible structures, such as squares, hexagons, or other polygons, which assure the compression and shape transformation of the fuel pellet during operation. Drawing out the entire reaction channel and using the other end to unlock the fuel, by removing all and refilling with appropriate material, may prevent the embitterment and incompatibility of the fuel structure. The fuel case 1114 and the fuel pellet 1111 may have a cylindrical shape, and the small pellets having cylindrical shape are simply added in the cladding tube and kept in contact by the compression force made by the lid devices mounted at the extremes of the cladding tube 1114. In this configuration the porous tube continuously contacts the cladding by guiding fins 1109. The cladding tube 1114 may have a variable cross section to form a frustum. In this case the pellet tube 1100 is discontinuous and together with the guiding fin 1109 creates a longitudinal lever 1111, and assures the pellet's external surface stability.

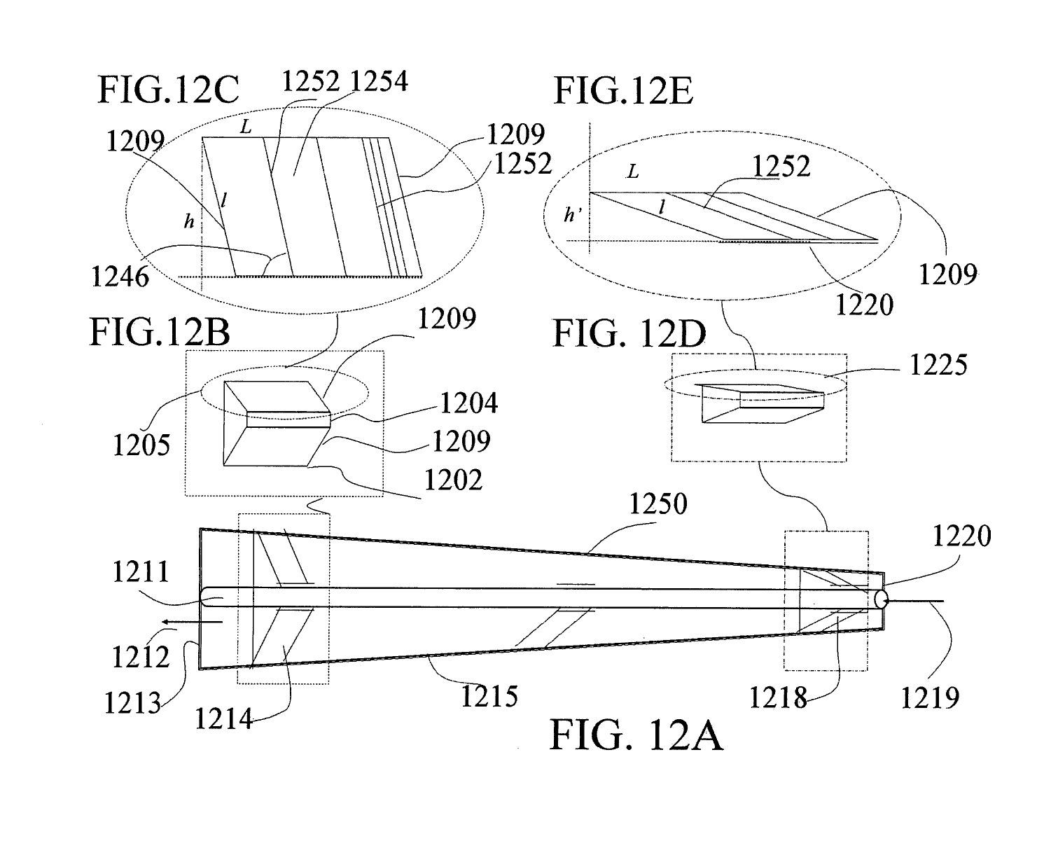

FIG. 12A is a schematic cross sectional diagram of still another embodiment of a fuel tube having a variable section in accordance with the present invention. FIGS. 12B-12E are enlarged schematic diagrams of various portions of the fuel tube 1250 shown in FIG. 12A. The structure presented in FIG. 12A-12E represents a mode of assembly of the fuel in order to maintain constant reactivity along the reaction tube and with burnup. The volume of the fuel varies with the burnup of fuel, i.e., a fuel pellet enters its life cycle with a specific density and starts to consume the active fuel by the burnup process. To maintain a constant criticality or increase criticality, it is needed to change the ratio of fuel/drain liquid by reducing the drain liquid volume between two adjacent fuel pellets. By changing the ratio, the criticality and homogenous power/temperature distribution among the fuel pellets can be maintained.

The reactor fuel tube 1250 includes: a cylindrical channel wall 1215, preferably double-channeled; permeable lids 1213, 1220; central tube 1211 having a porous wall and forming a passageway for drain fluid that is injected through one end 1219; and a stack of fuel meshes or conical disks 1252 that are similar to the disks 1110 shown in FIGS. 11A-11B. The fuel meshes 1252 are slowly pushed toward the tip of the tube 1250 during operation by one or more radial drive lever 1209 that may have a mesh structure. The drain fluid 1254 passes through the porous wall of the central tube 1211, in direction 1219 flows through the space between fuel layers 1252 to collect poison generated by fission reactions, and exits 1212 through the permeable lids 1213, 1220. It may also flow in the opposite direction. The cross sectional shape of the cylindrical wall 1215 may be circular, rectangular, hexagonal, or polygonal. The channel wall 1215 is shaped to reduce pressure drop of the drain fluid within the tube 1250.

The fuel meshes or conical disks 1252 are loaded into the tube 1250 by temporarily removing the lid 1213. Typically, the fuel meshes 1252 may be taken out of the tube 1250 at the end of a fuel cycle, wherein the fuel meshes 1252 are pushed from the base to the tip of the tube during the cycle. At the start of the fuel cycle, the fuel meshes 1252 may be located near a dotted region 1214 and has no poison therearound. As the fuel reactivity is high in the region 1214, a high volume of drain liquid between the fuel meshes is needed, i.e., fuel density is lowered in the region 1214. At the end of the cycle, the fuel meshes 1252 may be located near a dotted region 1218. Each fuel mesh near the region 1218 may contain less than ½ of the initial fuel; nevertheless, it is desirable for the fuel mesh to maintain good reactivity until being removed from the reactor.

The fuel tube 1250 behaves like a variable density tube for compensating the criticality loss due to the fuel burnup. At the initial stage of fuel cycle, the fuel has a high criticality. For example, a 1 Gw^{e} reactor consumes fuel about 2 Kg/day. Per year, it will consume about 750 Kg of pure fuel. In about 10 years of operation it will consume about 7.5 tons. Thus, to compensate for the criticality loss due to the fuel burnup, the initial mass has to be greater than 15 tons. The correlated action of the absorption rods and channel profile will allow the fuel, when coming out of the reactor, to lose 60-80% of the pure fuel.

The angle 1246 is continuously varied from the entry 1214 to the end of cycle 1218. FIG. 12B is an enlarged view of the fuel at the beginning of fuel life 1214. An enlarged view of a portion 1205 in FIG. 12B is shown in FIG. 12C. Likewise, FIG. 12D is an enlarged view of the fuel at the end of fuel cycle 1218. An enlarged view of an upper portion 1225 in FIG. 12D is shown in FIG. 12E. The fuel meshes 1252 are in contact with the external wall drive 1202 and pushed by a set of radial drive levers 1209 that couples the external wall drive 1202 to the inner drive tube 1204. The inner drive tube 1204 has a porous wall for allowing the drain fluid 1254 to pass therethrough. Due to the fuel's elastic force and fluid pressure drop, the radial drive levers 1209 pushes the guiding lever against the wall 1215. During the entire fuel cycle, the angle 1246 shrinks continuously as the wall drive 1202 and hollow tube drive 1204 slide with respect to the wall 1215 and the tube 1211, respectively. The reactor fuel tube lids 1213, 1220 may be connected to loading/unloading robotic arms.

As depicted in FIGS. 12C and 12E, the fuel meshes 1252 are squeezed by the central tube 1211 and the wall 1215 as fuel moves from the region 1214 to region 1218. As the fuel volume is approximately proportional the height of the parallelogram 1254, the density of the fuel may increase by a factor of 3 when the height of the parallelogram decreases by a factor of 3, for instance. Even though the mass of the fuel decreases with burnup, the tube 1250 makes the macroscopic density of fissionable material remain constant or vary in a predictable and controlled manner. The mesh, felt, or web containing fuel beads described in conjunction with FIGS. 6-9 are distributed on the mesh or conical disk in such a manner that the compression is performed at high levels to maintain the criticality.

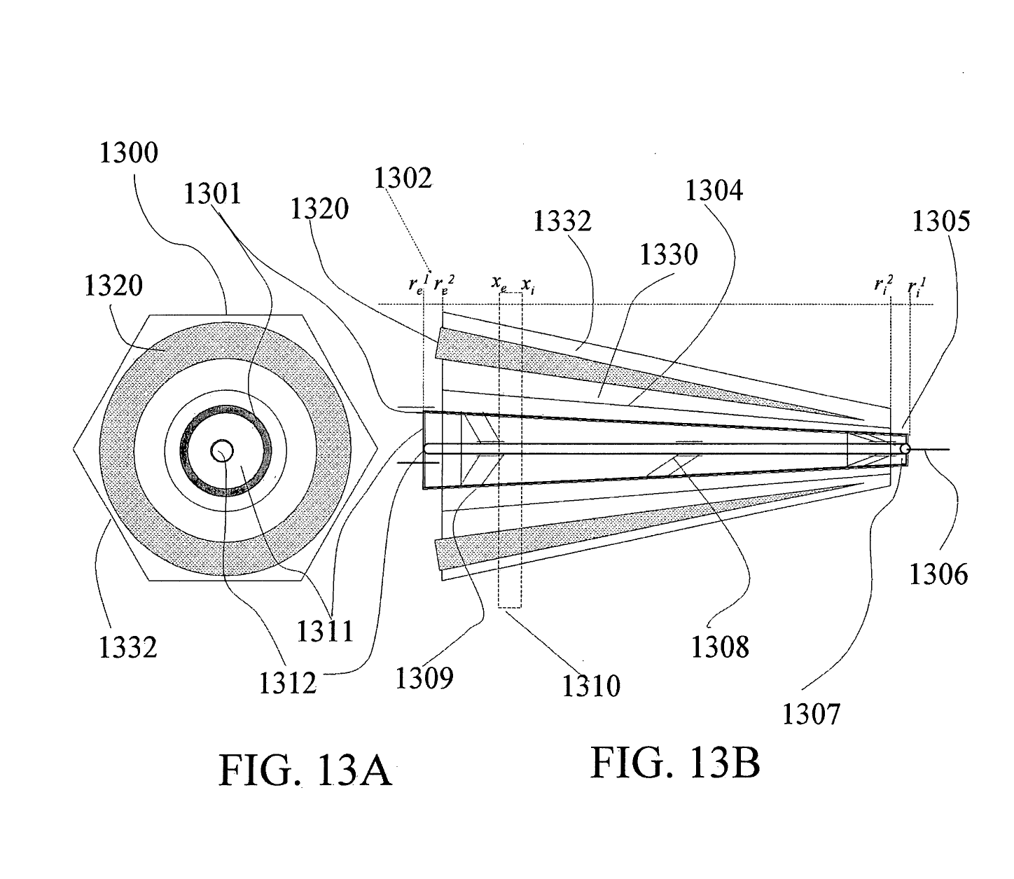

FIGS. 13A and 13B are respectively a schematic transverse and longitudinal cross sectional diagrams of an embodiment of a reactor channel module in accordance with the present invention. As depicted, the module 1300 has an outer hexagonal structure 1332 and an inner variable section fuel tube 1309. The hexagonal profile serves only as an example. A rectangular or triangular profile can be also used. The shape and dimension of the outer structure 1302 may be changed from case to case while the profile of fuel tube 1309 may remain unchanged. The reactor channel module 1300 may also contain safety devices which prevent overheating or melting of the structure and measure the heat flux from the tube 1309.

As depicted in FIGS. 13A-13B, the variable section fuel tube 1309 is similar to the tube 1250 in FIG. 12A and includes: a loading lid 1311 for loading the fuel pellet 1308; and an unloading lid 1307 for unloading the used fuel meshes or pellets. Drain liquid flows into the inlet 1306, while the loading lid 1311 has pores through which the drain fluid passes flow to exit the tube 1309. Cooling fluid flows through a passageway 1304 formed around the tube 1309. A structural element 1330 may be located around the passageway 1304. The central tube has the porous lid 1312. A technologic space 1320 surrounds the structural element 1330, wherein the space 1320 may include neutron absorbers, control rods, etc. A structural element 1332 surrounds the technological space 1320 and may have a hexagonal cross section. The fuel tube 1301 is fixed in the hexagonal reactor module 1300 and is loaded/unloaded by robotic arms in the area 1302 and 1305. From the reactor tube element the reactivity calculations are taking in account the entire section and its variation have to preserve the reactivity versus burnup. The fuel is displaced to compensate its burnup along the reactor channel.

As describe in conjunction with FIG. 12A, the adjustment of fuel density to a preset value is externally driven by a variable step screw or by a device for advancing the radial drive lever, (such as 1209) toward the tip of the tube 1309.

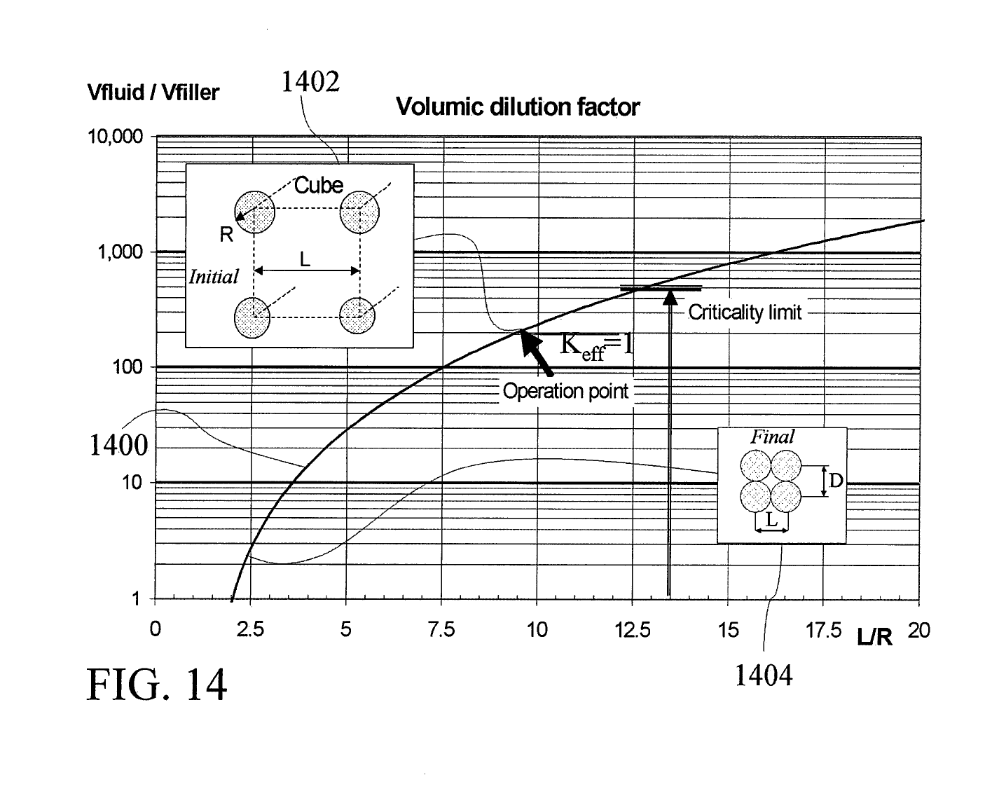

FIG. 14 shows a plot of volumetric dilution factor 1400 as a function of a volumetric parameter L/R, where L and R is the distance between two fuel beads and the radius of the fuel beads, respectively. An inset drawing 1402 shows the initial and final conditions of an exemplary cube, wherein the cube includes laterals made of imaginary compressible springs and fuel beads that are placed at the corners and have a diameter D. Initially, the corners are separated by a distance L that is greater than D and the distance L gets reduced by compression until the beads touches each other, i.e., L equals D. It is supposed that during burnup the diameter D of the beads do not change while the fissile material is removed from the bead, until the bead includes only the insulator shell. For the purpose of illustration, each bead is assumed to have an inner portion and an outer coating layer. The inner portion of the bead is a generator formed of fissile material and generates fission products. The bead is protected by a coating layer that insulates the generator from the surrounding environment, such as liquid metal, and is preferably a carbide nano-layer. Thus, in the present example, the beads are incompressible and consume the inner fissile material until they become empty shells. The variation of the distance L between the centers of the beads drives to the exclusion of the filling liquid from the volume inside, which corresponds to the variation of the concentration defined as the volumetric ratio between the drain liquid and fissile generator, Vfluid/Vfiller.

The plot 1400 shows the ratio Vfluid/filler as a function of the ratio L/R as the ratio varies from 2 to 20. As can be noticed, the ratio Vfluid/Vfiller varies by a factor of 2000 while the distance ratio changes by a factor of 10. This means that in the case of the lowest dilution at which the criticality needs be compensated, a variation of the ratio L/D from 15 to 2 yields a change of Vfluid/Vfiller by a factor of 1000, covering a wide range of concentration and thereby enhancing the burning ratio up to 99%. As an example, consider the case of Uranium Dioxide (urania) for which the beads diameter may be around 10 micrometers. The initial startup distance L may be 300 micrometers, while the ending distance may be 25 micrometers. During this entire compression path 99.9% of the uranium has been consumed. In reality, a burning factor of about 90% or higher might be achieved considering other safety factors applied to this fuel. Compared to conventional burning factors, the fuel usage is increased by a factor of 10.

The inset diagram 1404 shows the chosen fuel cells. Other elementary cells may be chosen to assure better compression factors. Also a combination of 1 part UC in 2 parts of UO₂ may be chosen to have a consumable cell eliminating CO₂, while the fission occurs, bringing a positive criticality variation due to the modification of the total neutron cross sections as a consequence of the burning, to compensate for the partial fission product retention in the bead.

As discussed in conjunction with FIGS. 6-14, various embodiments of fuel structure and fuel tubes include a fuel and drain/cooling liquid. Accordingly, the effective thermal conductivity of fuel may be different from conventional fuels.

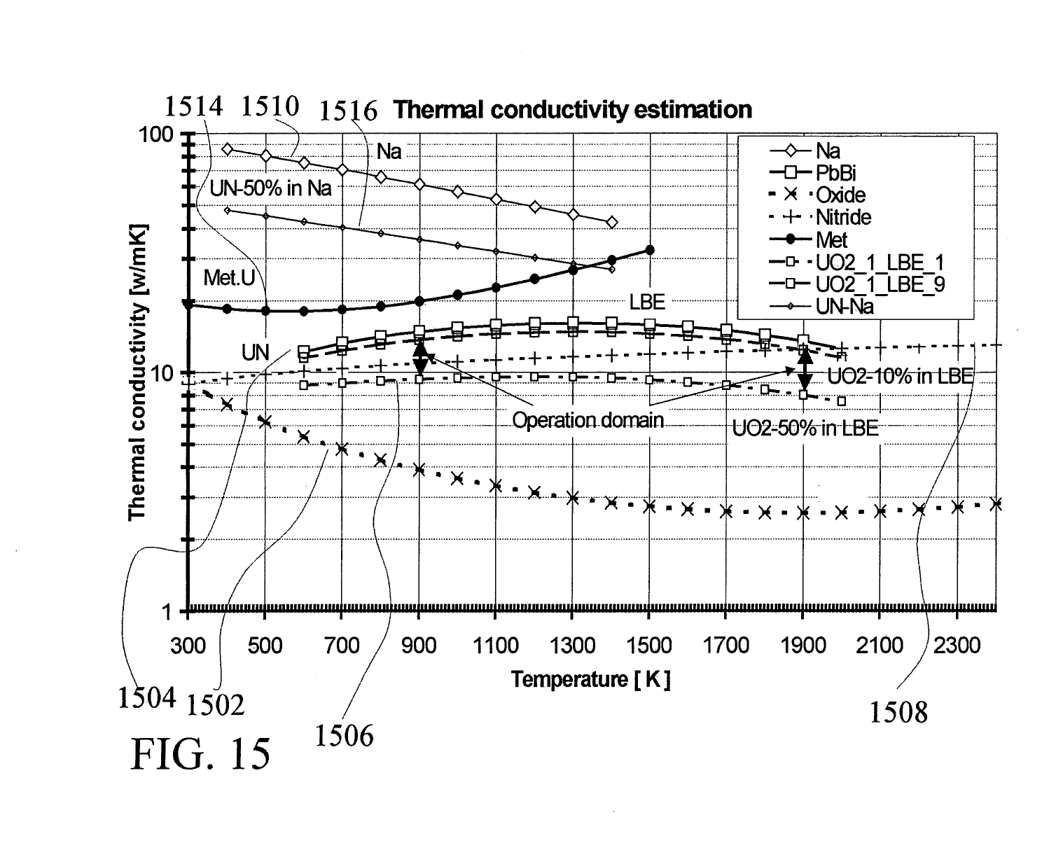

FIG. 15 shows a plot of effective thermal conductivity of various fuel types in micron level structure as a function of temperature. Curves 1502, 1504, 1508, 1510, and 1514 represent the thermal conductivity of UO₂, Lead-Bismuth Eutectic (LBE or PbBi), UN, Na, and metal Uranium. Curves 1506 and 1516 respectively represent the effective thermal conductivities of three fuel/liquid pairs: UO₂/PbBi and UN/Na. It is noted that the effective thermal conductivity is about 3 to 10 larger than conventional nuclear materials.

The effects of insulator on the thermal conductivity and thermal stress amelioration can be noticed. The insulator material with a role in providing adhesive forces also constitutes a higher conductive shell, with lower expansion coefficient than the material covered thereby. As such, the insulator will push the inside material as a superficial membrane, with a role in providing mechanical consistency and stability. Moreover, because the heat energy is deposited on the portion adjacent the insulator, the temperature inside the bead is homogenized. By this mechanism, the destructive temperature gradient inside the fuel may be reduced and the temperature is mainly constant inside the fuel and maintained at equal or slightly higher than the liquid interface temperature. In FIG. 15, it is visible that the major influence on the conductivity is given by the compression factor that varies the mass of the drain liquid. When the fuel is compressed, the ratio between the liquid (LBE) and the fuel decreases and thereby the total thermal conductivity will move down towards those of the fuel (urania). The compression can be used to compensate the deterioration of the fuel reactivity caused by the burnup

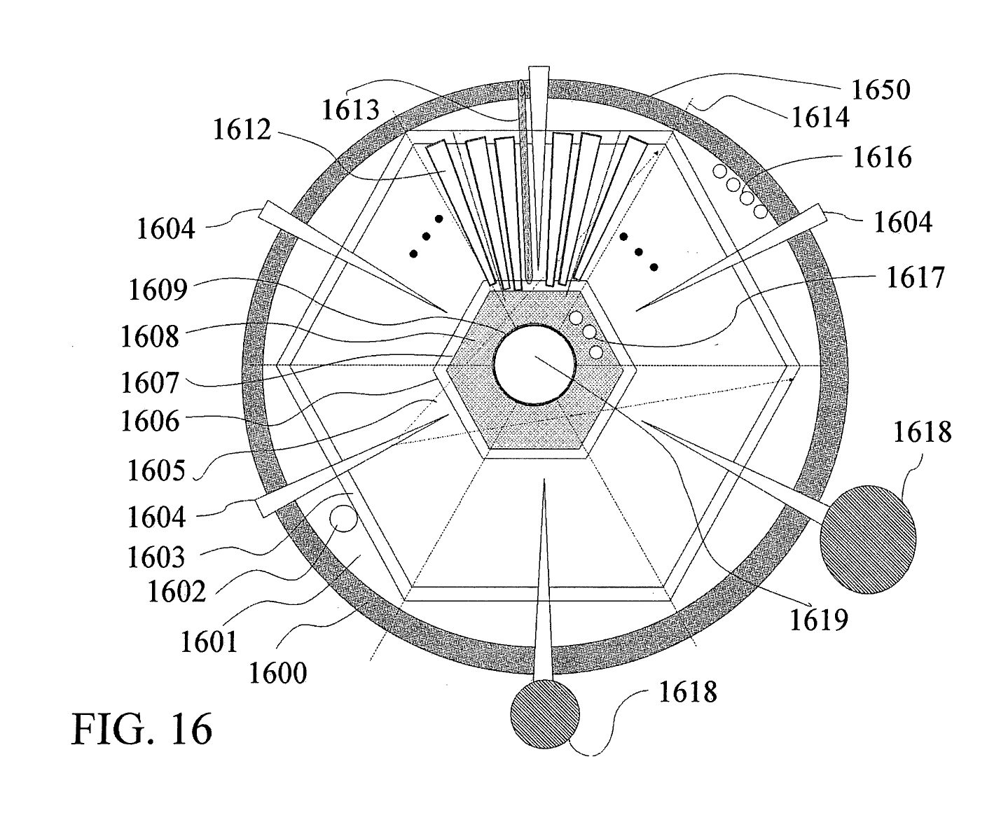

FIG. 16 is a schematic cross sectional diagram of an embodiment of a nuclear reactor in accordance with the present invention. The reactor 1650 is an accelerator driven variable geometry reactor and includes: a reactor blanket 1600; a reactor cooling liquid and technologic area 1601; one or more processing tubes 1602 for burning poisons and breeding; a drain fluid flow system 1603; neutron generation cones (betatron, annihilation, spallation) 1604 for generating driving neutron flux cone 1605; a reactor fuel zone 1606; a drain liquid flow system 1607; a central core cooling and neutron processing zone (moderation; multiplication) 1608; a central neutron generator converting shell 1609; one or more fuel tubes 1612 that have the same structure as the tube 1250 in FIG. 12A; a control/absorption rod tube 1613; processing tubes 1616 for poison burning, actinide transmutation, breeding; central processing tubes 1617 for poison burning, breeding; accelerator 1618; and a central neutron generator, fusion chamber or cavity 1619. In this design, the criticality is considered mainly for safety reasons. Drain fluid flows within the space defined by the drain fluid flow system 1603 to internal zone 1607.

The energy is produced by fission reaction, which depends on the neutron flux. The neutron flux inside the structure may have a linear dependence on the input neutrons, up to the sub-critical configuration where the neutron flux amplification occurs. At criticality, the neutron flux becomes independent of the input, or amplification becomes very high. Thus, external neutron generation is no longer required to maintain the reaction and it becomes self-sustainable up to supra-critical domain where the chain reaction develops exponentially into uncontrolled domain (explosion). The neutrons may be produced by electron accelerators, where electron accelerators also called betatrons, (with an extraction energy from 20 to 100 MeV/n), or by ion accelerators that discharge protons or heavy ions into spallation targets (at an extraction energy of 50 MeV/n) or by specific neutron release reactions in light nuclei (Be, Li). The annihilation energy of positron may also be used to generate neutrons by gamma-n reactions using giant resonance in nuclei. The combination of a fission discharge chamber at the center of a sub-critical structure with photo-fusion, or plasma discharge can be also used. Alternatively, an accelerator storage ring collider based or a sono-fusion neutron generator can be used.

As depicted, the reactor 1650 includes the reactor blanket 1600 that offers a high albedo, minimizes the neutron leakage, and absorbs neutrons that otherwise may escape from the reactor. The blanket for high temperature reactors has to be cooler than the center, so the cooling fluid 1601 is introduced from the border. Due to the fact that the actual waste treatment tubes are very difficult to control and require unpleasant reactivity variations and multiple chemical reprocessing stages, specialized pipes 1602 for burning poisons and breeding are used to control permanent reactivity and waste treatment. The drain fluid flows at the speed of few millimeters per hour. That is because, even after the fission products decelerate to stop mainly by the drain liquid, they have still excited nuclei and can further disintegrate by the beta decay process. After about a week, the average life-time becomes longer and the specific radioactivity falls by a factor of 10. During this period, for many reasons, it is better to contain the fission product inside the reactor and use the same shielding and heat removal system. When delivered to a separation unit, the drain liquid is still radioactive, so this unit 1603 has to be very simple and reliable. Alternatively, a remote processing of the drain fluid may be done by use of a pair of clean and contaminated tanks.

The reactor 1650 may be operated in a sub-critical condition in conjunction with an external controllable means. This requires a way to produce a controllable neutron distribution inside the reactor by use of neutron generation cones 1604. The neutron generation cones use a betatron with high WCu targets for energetic bremsstrahlung gamma rays exciting (gamma, n) resonances in fissionable product, spallation source on W, Pb targets, or simply by using the photons generated by electron-positron annihilation. Each of the neutron generation cones 1604 generates driving neutron flux cone 1605 on the opposite side of the reactor, enabling sector 1614 control of the power level.

The reactor fuel zone 1606 has a thoroidal shape and includes fuel tubes 1612 that may be of the type described with reference to FIGS. 12A-12E. It is noted that only six fuel tubes are shown in FIG. 16 for brevity, even though other suitable number of fuel tubes can be disposed within the zone 1606. Likewise, each component of the reactor 1650 may have other suitable multiplicity. For example, more than one rod 1613 can be used in the reactor 1650.

Drain fluid flows around the tubes 1612 and proceeds towards a central system 1607. It is not a requirement to impose a certain direction on the flow. The reactor may incorporate the future neutron production possibility based on fusion in order to harvest the energy of the fusion and amplify it by fission. For this to be accomplished, the central core cooling and neutron processing zone (moderation; multiplication) 1608 contains both a cooling and fusion cavity 1619. The fission is mainly conceived for laser confinement and accelerator colliding beams. Alternatively, a magnetic confinement fusion capability may be added in the cavity. Hydrogen isotopes based fusion reactions may be used to deliver ions as fusion product and fast neutrons. The neutron energy is harvested by a central neutron generator converting shell 1609 and a system of tiles made by the same material is used to convert the energy of the fusion products into electricity. The neutron generation conic tubes 1604 are interlaced among the fuel rod tubes 1612 and control tubes 1613 that have neutron-absorption rods.

The control and generation of neutrons in sub-critical groups are done by assigning a generator 1604 to an opposite conic driving neutron flow domain 1614 and using the accelerators 1618 for driving the generators 1604. The central processing tubes 1617 for poison burning and breeding reduce the need for supplementary absorbers while improving the neutron usage balance.

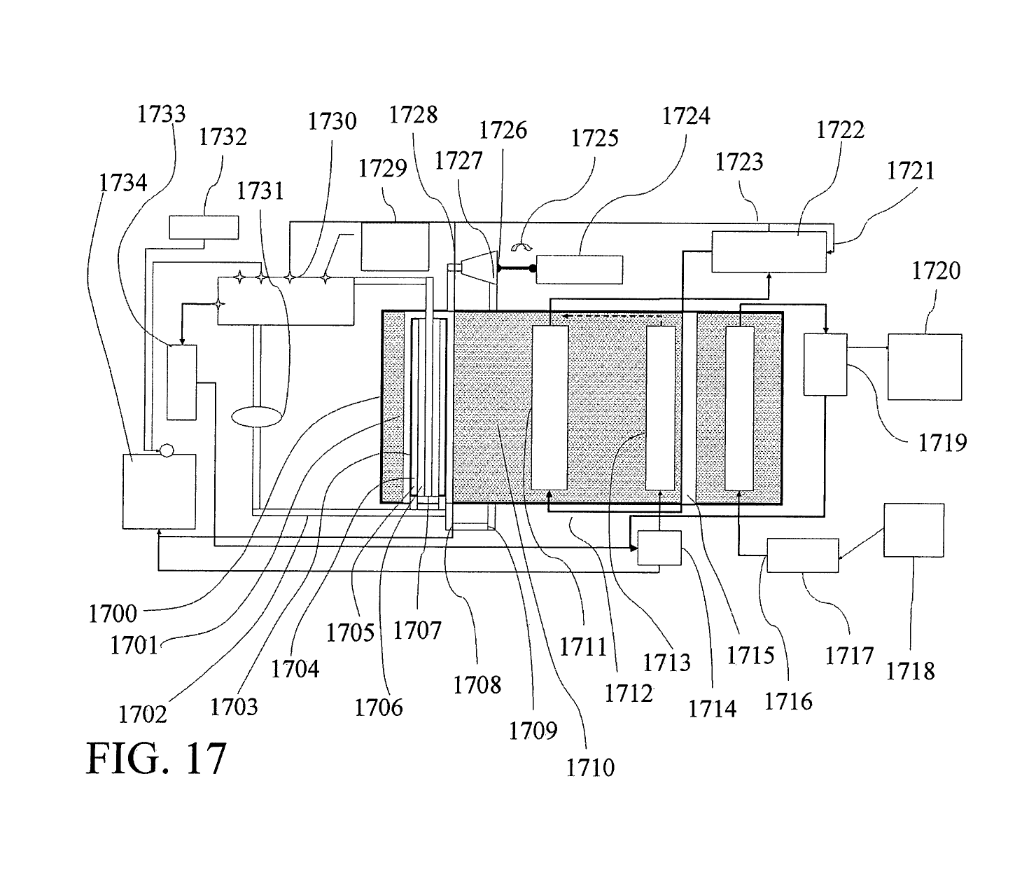

FIG. 17 shows a schematic diagram of one embodiment of a nuclear power plant in accordance with the present invention. The power plant includes a reactor 1700 may be of the type described in FIG. 16. It is noted that the position of each component in the drawing may not have a direct connection with the actual position as the diagram in FIG. 17 focuses on the functional aspects of the power plant. Also, in actual power plants, each element may have a suitable multiplicity, shape, dimension and position according to the design requirements.

The embodiment of the current power plant may have one or more of the following features. Firstly, the fuel without the compressibility feature to compensate for reactivity may be used in actual designs if the fuel pellets channels are modified accordingly. Secondly, controlling the poisons and actinides burning can be done in dedicated channels because of the burnup and reactivity issues. Thirdly, the fission products are to be continuously removed. Finally, the same power plant structure is good for breeding to generate high purity 239Pu, 233U at the level of calutron grade.

The reactor body 1700 contains the fuel tube 1701 with the drain liquid intake 1702. The nuclear fuel pellet 1703 contains a fuel mesh 1706 inside the pellet 1704, stabilized on a central tube 1707 for mechanic stability, and drain fluid inside the central tube 1707. The fuel handling area 1707 can be modified by adding lids for fuel handling and drain liquid circulation. The central rod and the exterior pipes 1702 and blanket have thermal resistors that bring the liquid metal into the liquid phase by maintaining the reactor's temperature over the melting point of the liquid metal.

The exit tube 1708 for cooling fluid is the same as conventional exit tubes. The cooling agent is PbBi (Eutectic)-LBE) liquid that gives mild or no reaction upon exposure to water. In Fast Breeder Reactors (FBR) structures, the LBE may be used as cooling agent too. The cooling fluid intake 1709 may have various designs. In the multitude of structures, the felt/mesh nuclear fuel may be used. In the hybrid structure, it will take the shape required by the design. For example, the intake 1709 has a vertical path in ultra high temperature reactor structure where the cooling is made by He gas, which powers a high temperature turbine, via a heat exchanger and circuit separator. In this case, the intake 1709 will adjust the flows such that the reactor's temperature field is maintained at constant level while the heat flow is to vary according the power requirements. The reactor bulk 1710, being a generic annotation, represents a multiplicity of the elements shown. The poison burning tube 1711 is designed to produce minimal amount of waste. The waste includes fission products (about 2 kg/day for each 1 Gw^{e}/day) that are all radioactive and chemically hazardous. A dedicated extension to control the reactivity of the waste and byproducts is desired, or in the simplest case these fission products will be sealed in cooled lead and delivered to a specialized separation plant for reprocessing.

The poison control system has a poison intake system 1712 that is connected to the specialized poison separation unit 1723, which processes the poisons coming from the internal system 1722, analyses, and purifies the output from the poisons exhaust 1721 and sent through the neutron treatment channel 1713 in order to maintain the reactivity under control. This is a liquid circuit that controls poison concentrations.

It is noted that actinides are not poisonous waste; they are nuclear fuel. The fissile compounds are further burned, or delivered as newly created fuel, while the fertile may be further reprocessed or delivered as they are. The actinide management unit 1714 is divided into two specialized units: fertile transmutation 1716 to breed into fissile material and fertile actinides management unit 1717 that makes the local reactor actinide breeding policy drive the actinides to the actinide separator or purifier 1733 or to the actinide burning tube 1713. The reactor may be equipped with neutron generator tube 1715 if it is a type of accelerator driven to maintain a sub-critical structure.

An improvement of the current embodiment of the power plant is the distinct breeder management unit 1719 which accomplishes the fuel policy, by supplying via Uranium, Thorium supply unit 1718, the fertile isotopes for transmutation into fertile, and delivered correlated with the fissile actinides. In the current embodiment of the power plant reactor, the new breeding product enters in equilibrium with the initial fuel, creating various plutonium grades used for other applications. In this structure, the neutron-capture products travel together with the fission products and are separated later. The new breeding is using mainly the neutrons in after reflector blanket. The neutron capture product is delivered through the fissile material output unit 1720 that separates and purifies the fuel produced by breeding in the dedicated channels.

The electric power production system uses hot cooling agent that comes after a chain of heat exchangers in the turbine inlet 1728 of the gas turbine 1727, cools down and is returned to the reactor system by the turbine's exhaust 1726. The torque control unit 1725 controls the turbine's revolution speed for the electricity generator 1724. Used fuel may be transported by the drain liquid pushed by the drain fluid recycling pump 1731. The pump 1731 is connected to the fission products separation unit 1730, which may trigger an alarm of the fuel quality management unit 1729. The separated fission products exhaust 1732 drives the fission products and byproducts to the delivery unit 1734 for reprocessing and storage so that the products policy is met.

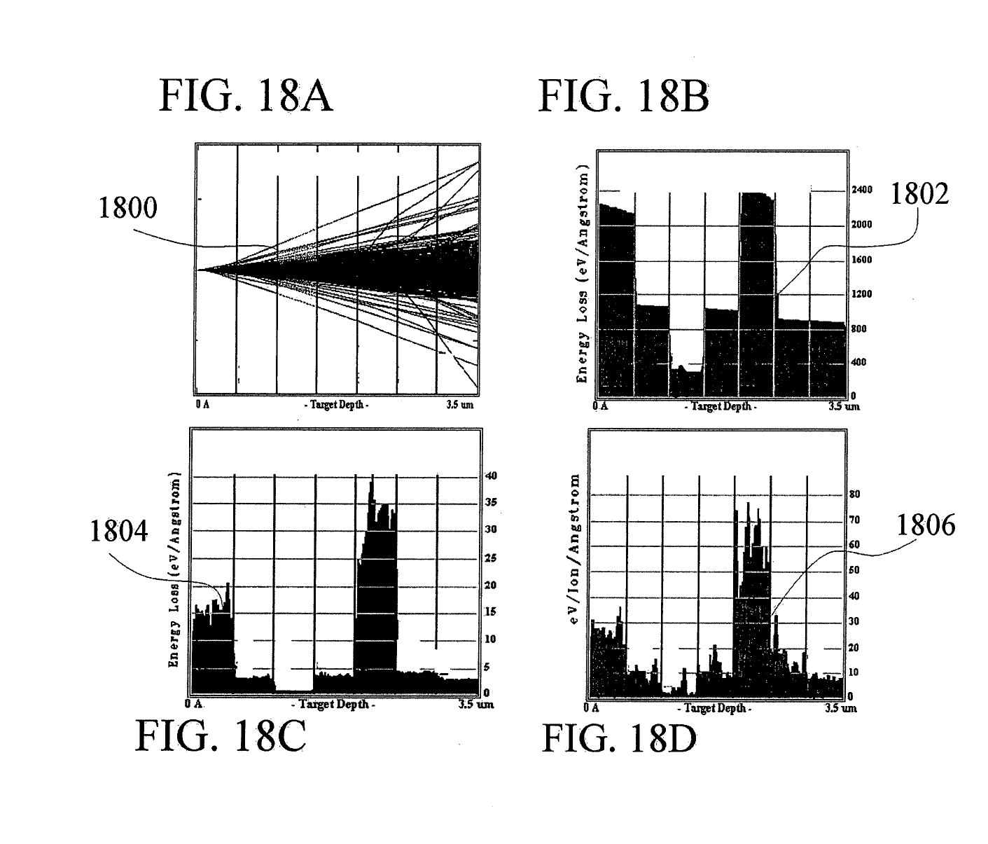

FIG. 18A shows a plot of exemplary trajectories of fission products, 100 MeV 140-Cesium atoms, 1800 penetrating a target that has multiple layers made from various materials. The first and fifth layers have high electronic concentrations while the third layer has a low electronic concentration and the rest are insulating layers, such as Teflon layer. As depicted, for thin layers of 500 nanometers thick, lateral straggling or angular deviations due to the interaction with the target electronic structures weakly perturb the trajectories of the fast moving nuclei.

FIG. 18B shows a plot of energy deposition by ionization 1802 in the target layers of FIG. 18A. A large difference between the “generator” type layers, the first and fifth layers, and the “absorber” type layer, the third layer, can be noticed. The “insulator” type layers have an average interaction with the nuclear particles.

FIGS. 18C and 18D respectively show plots of phonon energy (or, energy transferred to phonons) 1804 and recoil energy (or, energy transferred to recoils) 1806 in the target layers of FIG. 18A. As depicted, layers having actinides take less recoil compared to the layers having lead, even though both layers have high electronic densities. The figures also show that the energy to phonons and to recoils is less than 0.1% of the energy transferred to electrons and ionization. This means that the electronic transfer efficiency is greater than 99%. As such, a proper sequence in the target layers may reduce heat release to the target and allow cryogenic structures to become potential energy conversion devices.

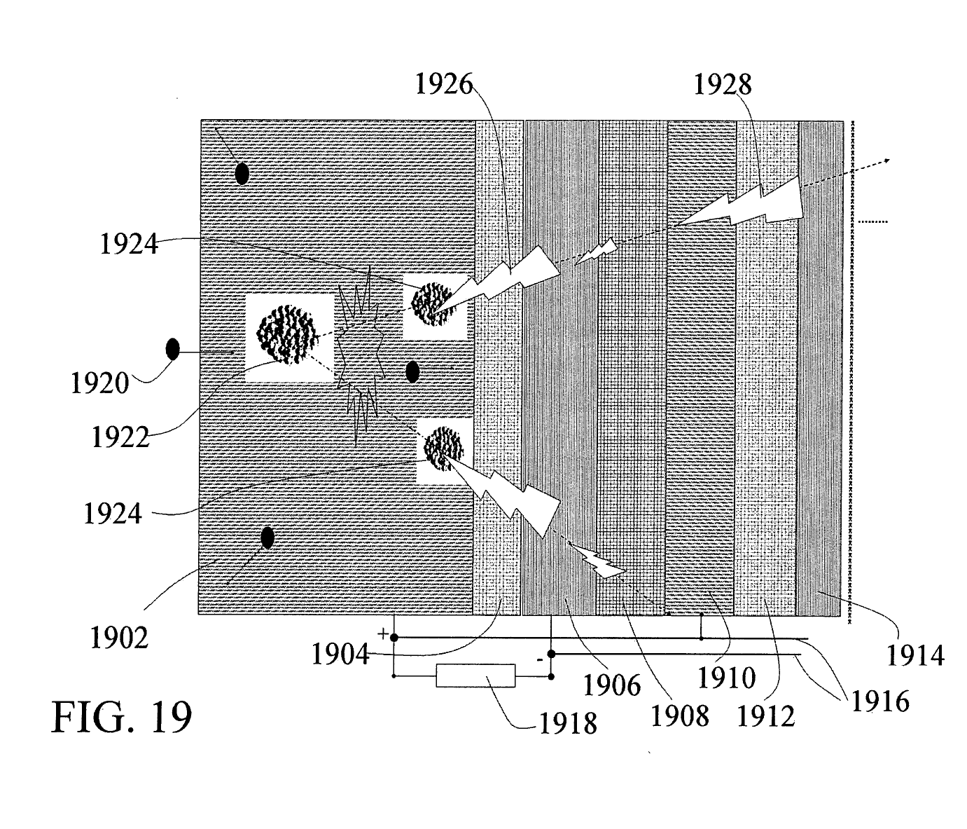

FIG. 19 shows a schematic diagram of an embodiment of a system for direct conversion of fission energy into electrical energy in accordance with the present invention. As depicted, the system includes: nuclear fuel 1902 including actinides and operative to generate fission reaction; insulating layers 1904, 1908, 1912; low-electronic density layers 1906, 1914; and high-electronic density layer 1910. As the high-electronic density and low-electronic density layers are conducting layers, the stack of layers 1904-1914 are referred to as “CIci” (Conductor-Insulator-conductor-insulator) layers. For brevity, only seven layers are shown in FIG. 19. However, the direct conversion structure may have any suitable number of CIci layers. Hereinafter, the term G^{fp-e} refers to a material which generates fission products and electrons, a double generator, and is also a conducting material that has high electron density, the term I^{exponent} refers to an insulator material and the exponent shows the type of insulation it provides, while the exponent may be fp, for fission products or e, for electrons. The term A^{e}, A^{fP} refers to a conducting material that has low electron density. The electron density is defined as number of electrons per volume when the volume is infinitesimally small. Typically, the high-electronic density material includes which have high collision cross section for the interaction moving particle knock-on electron, while the low-electronic density material includes material where this interaction is practically very small The electronic density vary from about 20 to 3000 electrons per cubic nanometer being an important parameter in knock-on electron yield. As depicted in FIG. 19, a neutron 1920 hits a fissile nucleus 1922 in the fuel 1902 and induces the fission reaction. The fission products 1924 fly apart taking about 80% of the reaction energy. The fission products 1924 may or may not take electrons with them but they interact with the neighboring atom's electronic shell to induce a shower 1926 of knock-on electrons. The fission products 1924 pass through the insulating layer 1904, together with the induced electron shower 1926. The fission products and electron showers enter into the absorption layer 1906 that stops the electrons to absorb the electronic shower and become polarized with a negative charge. The absorption layer may not interact with the flying fission products. The flying fission products 1924 pass through another insulating layer 1908 with no or minimal interaction, and enters into a generator or high-electron density layer 1910 that may or may not content fissionable products. The high-electron density layer induces a new electronic shower 1928 that tunnels through the insulating layer 1912 and stops in the next low-electron density layer 1914. The process of generation and absorption of electron showers repeats until the fission products 1924, which are ionization agents, loose all their kinetic energy and stop.

The “generator” layer with high electronic density remains polarized positively as it looses electrons, while the “absorber” layer with low electron density polarizes negatively as it stops the electrons. If the charges generated in these layers are not removed, an electrical potential builds up to the insulator's breakdown limit. If a suitable circuit 1918 is coupled to the plus (generator) and minus (absorber) layers by electrical connections 1916, an electrical energy can be directly harvested. To make effective CIci layers, it may be necessary to produce stable material interfaces, which can be realized by use of proper shapes.

The thickness of each layer may be in the nanometer range. For example, the thickness of a generator or high electron density, layer, if made of Gold (198Au), is about 30-55 nm, with an insulating layer made of SiO₂ or Al₂O₃ and having a thickness of about 5 nm, and an absorber or low electron density layer made of Ti or Al and having a thickness of 15-25 nm. These layers may be repeatedly stacked in a thickness decreasing pattern to form a CIci structure that has an effective thickness of about 12 microns or more and terminates in PbBi liquid. The CIci structure may be manufactured by an ion beam assisted chemical vapor deposition technique, alternating the processes of gun deposition and ion etching. Another approach is to produce the generator layer from an actinide based superconductor that has both semiconductor properties and high electron density and is capable of generating electron showers and fission products, wherein the actinides and superconducting material are structurally interlaced.

The electronic cloud belonging to various atoms of the fuel is strongly perturbed by the fission product movement and associated radiation. The main process is ionization of the nuclei. While Fermi level is around few eV, the ionization energy drop is of about several KeV/Angstrom. Typically, an atom has a diameter of several angstroms. This simply means that the interaction of fission products with matter perturbs internal electrons in the lower orbits of the matter atoms and in turn removes the internal electrons from the atoms. As each electron has enough energy to share with the other electrons on its path, a nano avalanche, or equivalently electron shower, is created mainly in the direction of the flight path of fission product for impulse conservation reasons. Some other measurements show that when the energy of electrons reaches under a hundred eV, the path length basically becomes independent of the energy and becomes a measure of the Debye length. All the process of fission product stopping and electronic shower absorption is taking place in few pico-seconds, while the de-excitation and the equilibrium are reached in nano-seconds, being based on the return of the dislocated electrons back in structure under the action of the electric forces created by the polarization induced by the dislocations. The concept of direct conversion also relates to the interruption of the path of electron nano loops by use of a CIci structure. Generator, absorber and insulator materials have nanometric dimensions in order to be effective. For electrical polarization reasons, the network is insulated at element level, allowing the voltage to be accumulated as in a capacitor. The conversion efficiency is given by the ratio of the difference between the two avalanches over the total created charge. Typically, the insulator has a high breakdown margin to accommodate substantial accumulation of charges in the generator and absorber layers. The electrical potentials are in the domain of milli-Volts. In the interface between a cluster and an insulator, the quantum behavior may favor the exciton-phonon interaction, harvesting energy from all the possible modes and putting it in electric energy or making the polarization effects vanish. Moreover, the path is preferably short, because the volume distributed conduction is competing with the low resistance path conduction.

It is noted that the CIci layer can be applied to the fuel described in conjunction with FIGS. 6-9. For instance, the fuel bead 801 may be coated with the CIci layer to directly convert fission energy into electrical energy and the wires 802 can be used to collect the electrical energy.

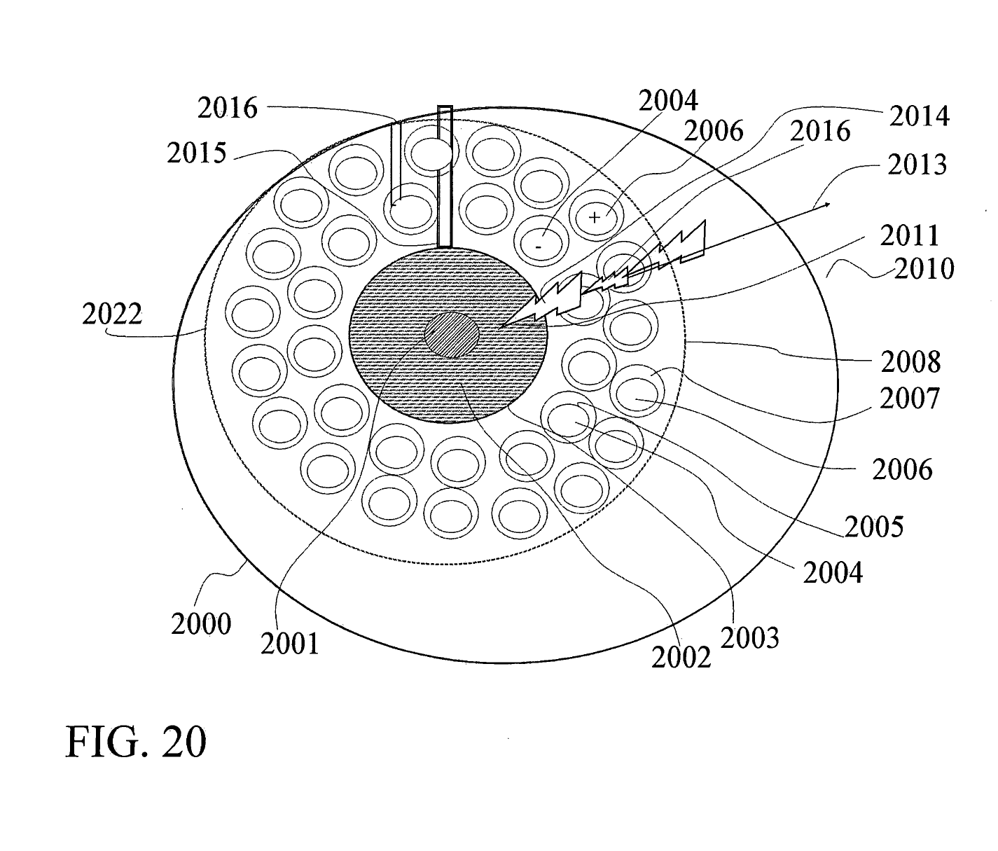

FIG. 20 shows a schematic cross sectional diagram of another embodiment of a device for direct conversion of fission energy into electrical energy in accordance with the present invention. The fuel spherule 2000 is encapsulated in an outer shell and surrounded by a drain liquid 2010 that finally stops the fission products. The radius of the outer shell 2000 may be about 90% of the effective fission range. The fuel spherule 2000 has the fissile material inner core 2002 surrounding a hard core 2001 made from mechanical support materials like tungsten wires like 802 (FIG. 8), conductive materials, same fissile material as 2002 or can remain empty. As variations, the core 2001 may be an empty space or a conducting material that serves as a conducting wire for harvesting electrical energy. The dimension of fuel 2001 is of several microns, surrounded by an insulator and delta layer 2003 for potential adaptation. The fuel spherule 2000 also include one or more low-electronic density components 2004 that are made from electron absorber material, have a nano-wire like structure, and are surrounded by insulating layers 2005. The term “nano-wire like structure” represents the structure depicted in FIG. 9, wherein the wire thickness is in the nanometer range and may not be cylindrically shaped like conventional wire. The low electron density components 2004 may be also made of nanocrystals. The fuel spherule 2000 also includes high-electronic density components 2006 that are made from electron generator material, wherein the generator components have the same structure as the absorber components. Insulators 2007 that have a high transmission and a relatively high breakdown voltage surround the generator components 2006. The inner shell 2008 is designed to assure mechanical and electrical stability. The inner shell 2008 is made from conducting material and spans over one or more fission-to-electronic-flow transformation repetitive layers and provides an iso-potential as well as mechanical support for the contents therewithin. This “CIci” structure 2004, 2005-2007, 2006, 2007 repeats itself many times (10-20 times for each micron) until it reaches the borders where the fission products absorbent layer 503 (FIG. 5) begins. For the fission products the core 2003 is the generator 501 (FIG. 5) and all the direct conversion structure following it near the outer margin is a larger insulator 502 (FIG. 5) which integrates the border layer 2000, which stops the outer fission product absorber 2010 similar to 503 (FIG. 5) to reach inside the structure.

Fission products generated somewhere 2011 in the fissile fuel 2002 may have a flight path 2013 and generate an electronic avalanche 2014. Then the fission product penetrates the electrons absorber component 2004 it stops the previous electron shower that tunneled through the insulator 2005-2007 but, generates small avalanche 2016 or no-avalanche, and reaches the electron generator components 2006 to generate a strong avalanche 2014. For brevity, only one layer of A^{e} electron-absorber components and one layer of G^{e} electron generator components are shown in FIG. 20, even though other suitable number of layers can be used without deviating from the spirit of the present teachings. For a fuel spherule having multiple layers of I^{e} and G^{e} components, the fission products may travel through one or more of the layers until they reach the drain fluid 2010. All over the path 2013, the polarization 2006, 2007 appears due to charge dislocation and accumulation. An electrical circuit including the electric conductors 2015 and 2016 transports the accumulated charges outside the fuel spherule 2002 to harvest the electrical energy.

The fuel spherule 2000 may be fabricated by ion beam assisted chemical vapor deposition on small targets. Starting from a tungsten, gold, Cu micro-mesh, the vapor deposition of fuel, such as Uranium or Plutonium, is made for a thickness of several microns. Over it, a several nanometers of dielectric material, such as carbon layer, is deposited by an electron beam, stimulating the formation of carbide layers. Then, a metallic layer is deposited followed by formation of insulation by reaction with oxygen, carbon, iodine and formation of dielectric material. Then, a stabilization element is added that reduces diffusion and layer degradation. A new conducting layer is deposited with a thickness of several nanometers, followed by formation of dielectric material and stabilization. A short electron beam or laser selected frequency is applied to anneal the layer, clusterize, and stabilize the structure.

A masking technique may be applied to make asymmetric depositions so that all the layers of one type are in contact with an end of the fissile bead. One type of material is in contact with an interior support conductor while the other is in contact with the exterior. An annealing process may be used to create a nano-wire like structure that will maintain the group conductivity. A several centimeter long wire with beads of fuel surrounded by the nano-wire like structure may be produced. The central nano-wire conductor is made of conducting material, such as Au, Ag, or Cu, has a diameter less than 1 micron and able to carry a current of several microamps. Then, a bead structured fissionable material having a radius of several microns is deposited, followed by a hundred of repetitive “CIci” layers connected to the center and the exterior. A very thin conductive exterior layer 2022 is deposited to cover the entire structure, wherein the conductive layer increases the electric contact with the drain liquid that serves as an electrode.

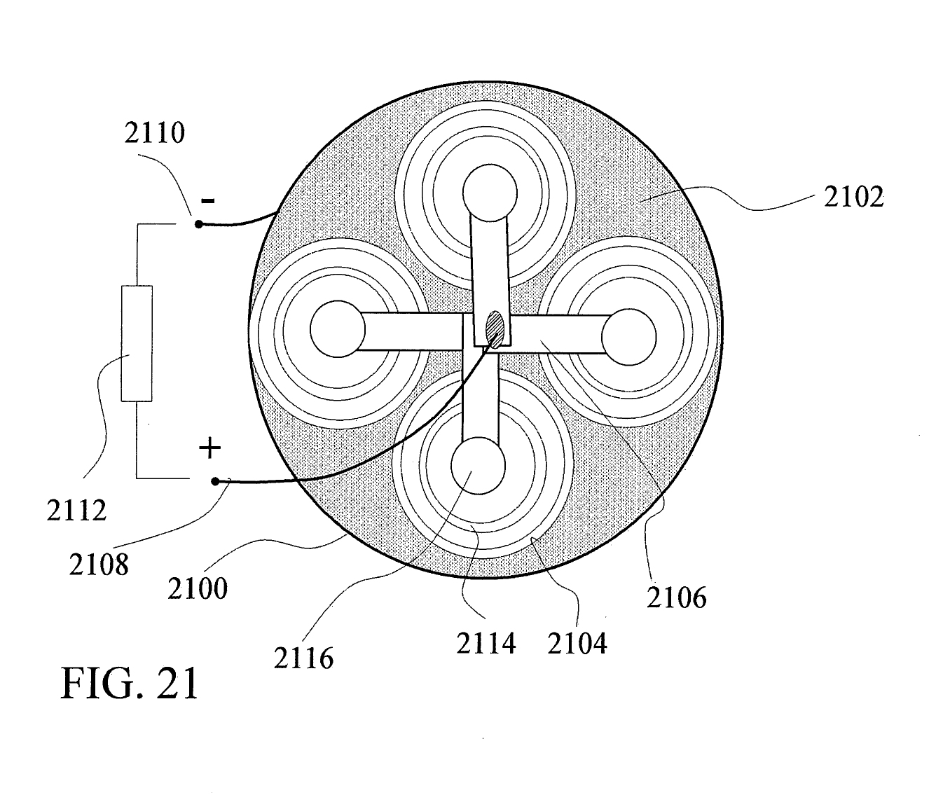

FIG. 21 shows a schematic cross sectional diagram of yet another embodiment of a device for direct conversion of fission energy into electrical energy in accordance with the present invention. As depicted, the device includes a shield 2100 that contains drain fluid 2102 and a plurality of fuel spherules 2104. The shield 2100 may have a nano-layered structure and be formed from a conducting or dielectric material. Each fuel spherule 2104 have the similar structure as the spherule 2000 in FIG. 20 with a hot wire core 2106 made of conducting material. In the present embodiment, the core of the spherule 2116 corresponds to the core 2001 in FIG. 20 and is filled with conducting material and connected to the hot wire 2106. The hot wire 2106 are connected to each other in parallel and coupled to an electrode 2108. The drain fluid 2102 is connected to the conducting wire, such as 2116 in FIG. 20, that is coupled to the low-electron density component in the fuel spherule 2114. The drain fluid 2102 is also connected to an electrode 2110. A circuit or conversion 2112 unit for harvesting electrical energy may be connected to the two electrodes 2108, 2110, wherein the two electrodes are oppositely polarized.

For brevity, only four spherules connected in parallel are shown in FIG. 21. However, it should be apparent to a skilled artisan that other suitable number of spherules can be used without deviating from the spirit of the present teachings. Antennas extending from the bead's low conductive shunts serve as springs in creating the fuel's 3D elastic structure, which allows dynamic reactivity adjustments by varying the amount of drain fluid 2102 contained in the shield 2100.

The polarization of the electrodes 2108, 2110 in this super-capacitor structure is transmitted through the wires to a conversion unit 2112. To have a power level of 1 w for each cubic millimeter, an activity around 1 Curie is required, but the capability of existing materials for carrying current is limited. In such cases, cryogenic super-conductive structures can be considered. A practical delivery parameter can be 10 A at 10 mV, which corresponds to the limit of existing materials having a cross sectional area of 1 mm². Supra-conductive technology opens the way to increase this limit by a factor of about 100. In these circumstances, activities up to 100 Ci/cmm are feasible, while operating with an efficient structure at liquid helium (LHe) temperatures. Pu based super-conductor alloys can make such structures operational at Liquid Nitrogen (LN) temperatures. For example, PuCoGa₅ has a critical temperature of 18 K and there are many other high temperature supraconductors made from materials with low neutron interaction cross-section. For these application, a recovery mechanism may be conceived when parts of the reactor are raised to higher temperatures to eliminate the fission products and cure themselves by annealing.

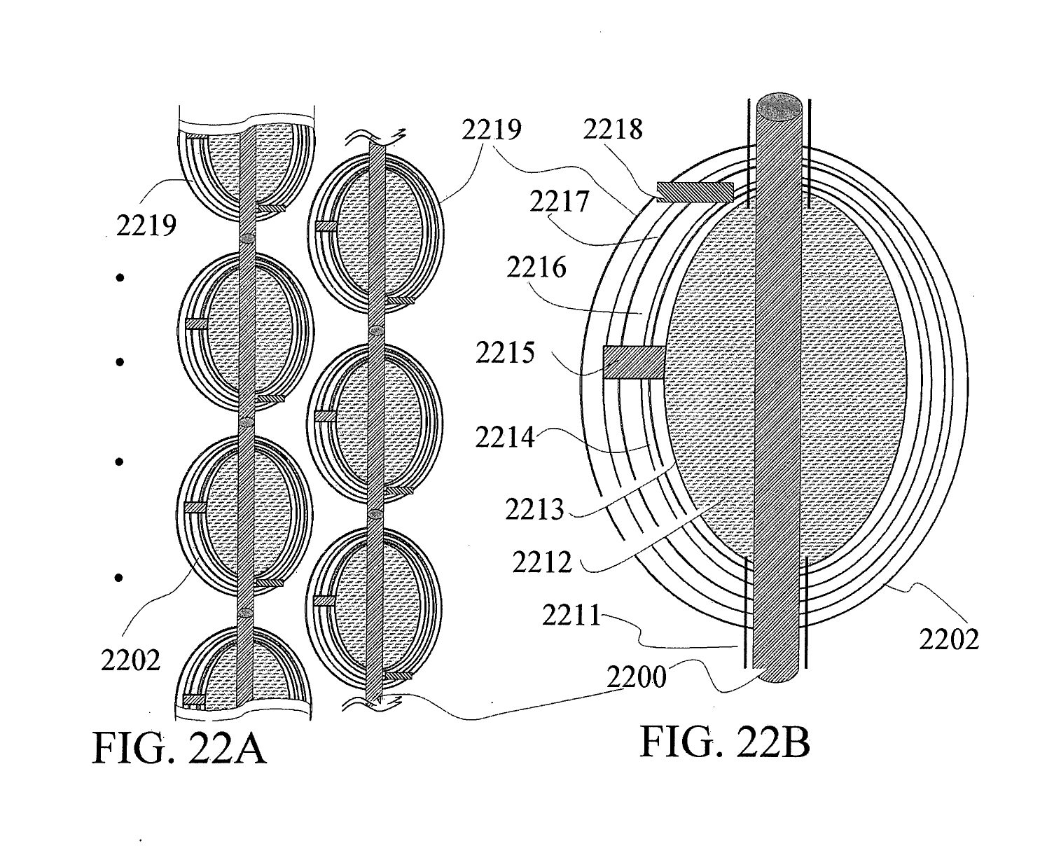

FIG. 22A is a schematic cross sectional diagram of still another embodiment of a device for direct conversion of fission energy into electrical energy in accordance with the present invention. As depicted, a plurality of spherules or voxels 2202 are connected to wires 2200. FIG. 22B is an enlarged schematic cross sectional view of a voxel 2202. The nano-wire like structure in FIG. 22A can be manufactured by metal organic chemical vapor deposition technique. The wires 2200 are formed from conductive material, such as Au, Cu, Ag, W, U, etc. The insulating layer 2211 is formed by applying an ion implanted reactive gas to generate covalent insulator structures like oxides, carbides, fluorides, or combinations thereof. The breakdown value of the insulating layer 2211 is in the range of tens of miliVolts up to several Volts, where the thickness of the layer is in the nm range. The voxel 2202 includes a fuel bead 2212, which is made of high electronic density material, such as U, Pu, Np, Am, Cf, etc., has a dimension of few microns, and is capable of generating fission reaction therein. It is preferred that the fuel bead dimension is small, or the bead fissile material is integrated in the wires creating fission places all over the material, coated with a harvesting layer.

On the surface of the fuel 2212, a faceted and stabilized insulating layer 2213 having a thickness of few nanometers is deposited. The insulating layer 2213 separates the fuel 2212 from a low-electron density layer 2214. The low-electron density layer 2214 has a role of electronic shower channeling on the surface's facets.

In order to completely close the electronic loops, a conductive shunt 2215, generated by ion implantation, is disposed. The conductive shunt 2215 is connected to all of the absorbent layers in the voxel 2202 so that the low-electron density layers are at the same electrical potential. The low electron density layer 2214 is surrounded by another insulating layer 2216 and a faceted delta layer 2217 that is formed of a high-electron density material. The layers 2213, 2214, 2216, and 2217 form a CIci layer structure. Additional sets of CIci layers may be stacked on the outer surface of the delta layer 2217 until the total thickness of the CIci layers reaches about 90% of the fission product range. Another conductive shunt 2218, which is connected to generator layers, may be grounded. As the voxels 2202 may be immersed in drain liquid during operation, the outermost layer of the voxel 2202 may be formed of a conductive material to enhance the electrical conduction at the interface and stabilizes the voxel content in the drain liquid. Multiple fuel-beaded wires 2219 are connected to create a bunch of wires with a macroscopic dimension and to produce power extraction at the level of 1 W/mm³. It is noted that harvesting the energy of a single disintegration at 80% efficiency may generate an electrical current of 3.2 nA at 10 mV. The multiple-beaded wire 2219 is a super capacitor formed of material that is neutron flux compatible. The properties and structure of the fuel bead 2219 may be produced for all the shapes defined in FIG. 6-9, the harvesting layers for fission products are looking like an extended fission products insulator layer when the harvesting layers have no actinides in their composition or as a mixture of generator and insulator when the high electronic density materials contains actinides as in the case of PuCoGa₅, etc.

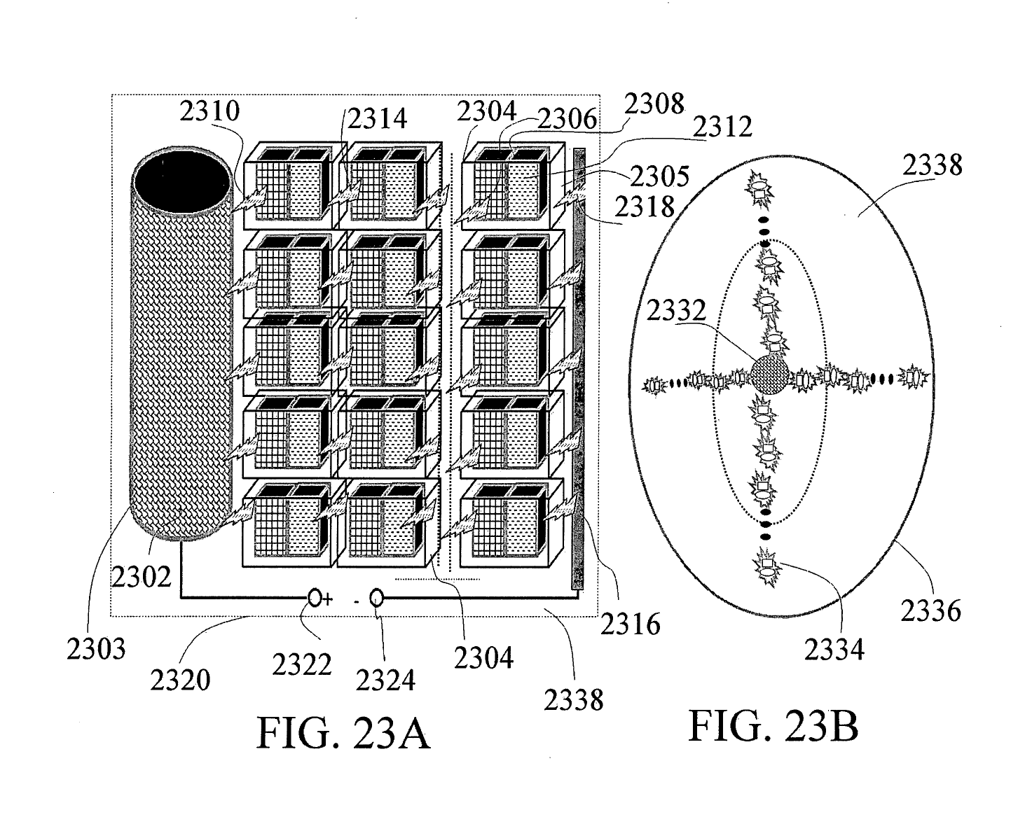

FIG. 23A is a schematic diagram of a further embodiment of a device for direct conversion of fission energy into electrical energy in accordance with the present invention. As depicted, the device includes a cylindrical fuel 2302, which is made of high electronic density material, such as U, Pu, Np, Am, Cf, etc., has a dimension of few microns, is capable of generating fission reaction therein, and is covered by an insulating layer 2303. The fuel 2302 may have other suitable geometrical shapes. The device also includes a matrix of cells 2304 that are bounded by a layer of low-electron density material 2316. Each cell 2304 includes a box 2305 that holds a low-electron density component 2306 and a high-electron density component 2308. The absorber and generator components are formed as a bimaterial bead in good electric contact and are surrounded by an insulating layer 2312. The insulator separates the beads that are oriented with the absorber from the fission products generator. The fuel 2302 generates both the fission products and the knock-on electron showers 2310, which in turn are absorbed by low-electron density components 2306. The high-electron density components 2308 generate electron showers 2314 by interacting with fission products flying therethrough. The absorbent layers 2306 absorb electron showers to have a negative polarization, while the fuel 2302 has a positive polarization. A suitable energy harvesting circuit may be connected to the two electrodes 2322, 2324. Optionally, the device may also include an outer shield or case 2320 that encloses the fuel 2303, the cells 2304, and drain liquids 2338 flowing around the fuel and cells.

It is noted that the device includes only one matrix of cells 2304. However, other suitable number of matrices of cells can be located around the fuel, where each matrix extends in a radial direction. FIG. 23B is a schematic top plan view of another further embodiment of a device for direct conversion of fission energy into electrical energy in accordance with the present invention. The device includes an insulated cylindrical fuel 2332 and a plurality of cells 2334 positioned around the fuel 2332. Each cell 2334 is the same as the cell 2304 in FIG. 23A. Optionally, the fuel and cells are enclosed by an outer shield or case 2336, wherein drain liquid 2338 are contained in the case.

Due to the fact that each electronic loop cannot be extended very long, the loop length extends with only few orders of magnitude. In normal ceramic fuel the electron micro-loop (electron path) is less than few microns long, in a medium with the resistivity of hundreds of Mohm-m. When this loop is cut by the conductive layers with resistivity of mili-Ohm*m their length may not exceed few meters because the electrons will have same chance of following the long exterior path or traveling back through the insulator (it is called the minimum action principle invented by Fermat) So, from micron long electronic loops in dielectric, the new loops through normal conductors can be about ten millimeter long only. As such, it is beneficial to connect voxels in a pyramidal structure. To harvest electrical energy in nano-wire structured devices, many wires are connected in parallel and assembled in a bunch, wherein the wires are compacted into a structure immersed in drain fluid. The presence of the drain fluid as conductive layer is not a requirement. However, if the drain fluid is missing, an equivalent conductor has to be installed.

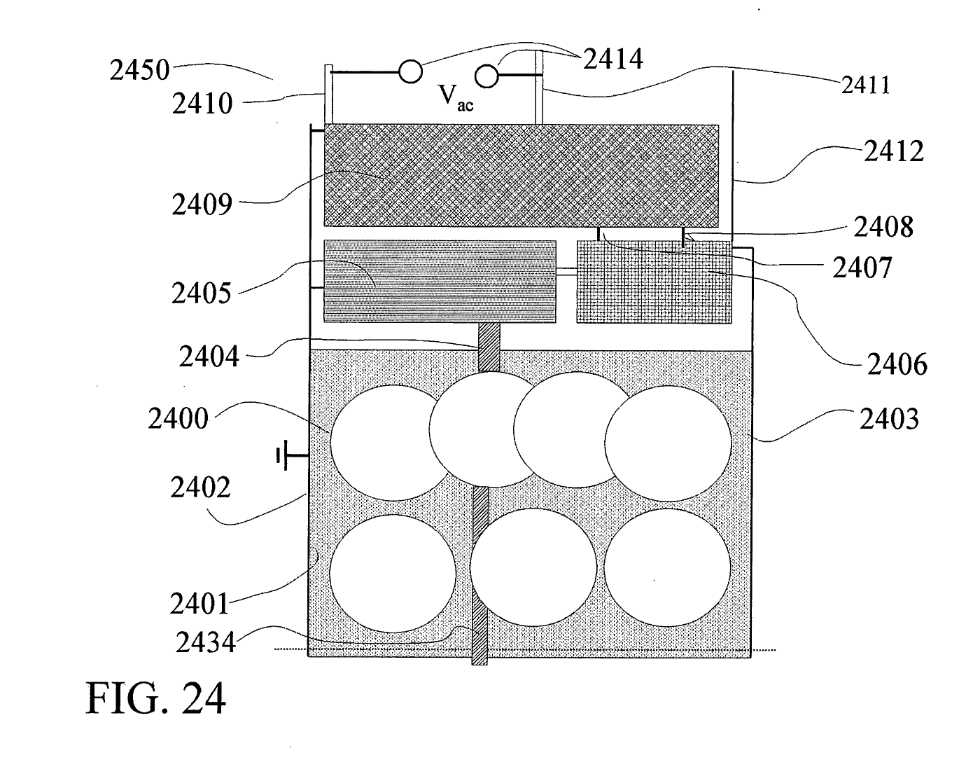

FIG. 24 is a schematic diagram of yet further embodiment 2450 of a device for direct conversion of fission energy into electrical energy in accordance with the present invention. The device or module 2450 includes multiple fuel spherules or voxels 2400, each of which is similar to the voxel 2202 in FIGS. 22A-22B. The voxels 2400 are connected in parallel to an optional condenser unit 2405 via a central conductor 2404. Each voxel 2400 has an outer coating layer formed of a conducting material. Drain liquid 2401 operates as conductor, but when it is not used, additional conductor (not shown in FIG. 24) is needed to connect all of the spherules' outer conductive coating layer. The drain fluid, or alternatively conductor coupled to the outer coating of voxels, is grounded by one or more wires 2402, 2403. Each spherule may have other suitable cross sectional geometries, such as triangle, square, hexagon, to provide modularity and interchangeability.

The central conductor 2404 is connected to the optional condenser unit 2405 and to a MEMS switch device 2406 that continuously alternates the polarity of current flowing out of the condenser unit 2405 so as to create an alternating current at a pair of electrodes 2407, 2408. The MEMS switch 2406 is controlled by a synchronization signal 2412 received from a central unit, and delivers alternating current through the switch's conductors 2407, 2408 into a micro-ferrite transformer 2409. The transformer 2409 raises the voltage level by at least 100 times, from millivolts to several volts, before the current is delivered to the conductors 2410, 2411. The current at the electrodes 2414 is also used by a centralized control system to diagnose the reactivity level and, in conjunction with the measured temperature of the voxels, to control the voxel's operation quality.

The voxel elements in FIG. 24 deliver harvested energy to an upper conversion level that sums the energy and transforms into a current of a higher voltage, preferably in the range of tens- to hundred volts. The voltage increase reduces the current that the conductor sections can carry. In superconductor structures, it is possible that this volume can be further reduced if the conversion efficiency is high (about 99%) so that all the fission energy is converted into electricity. The equivalent MEMS DC/AC converter can be achieved by a modified superconductor quantum interface device (SQID) structure using a driving current to control the magnetic field through a Josephson junction. For a harvesting voxel redundant DC/AC converters may be applied in a multiple access fail tolerant structure.

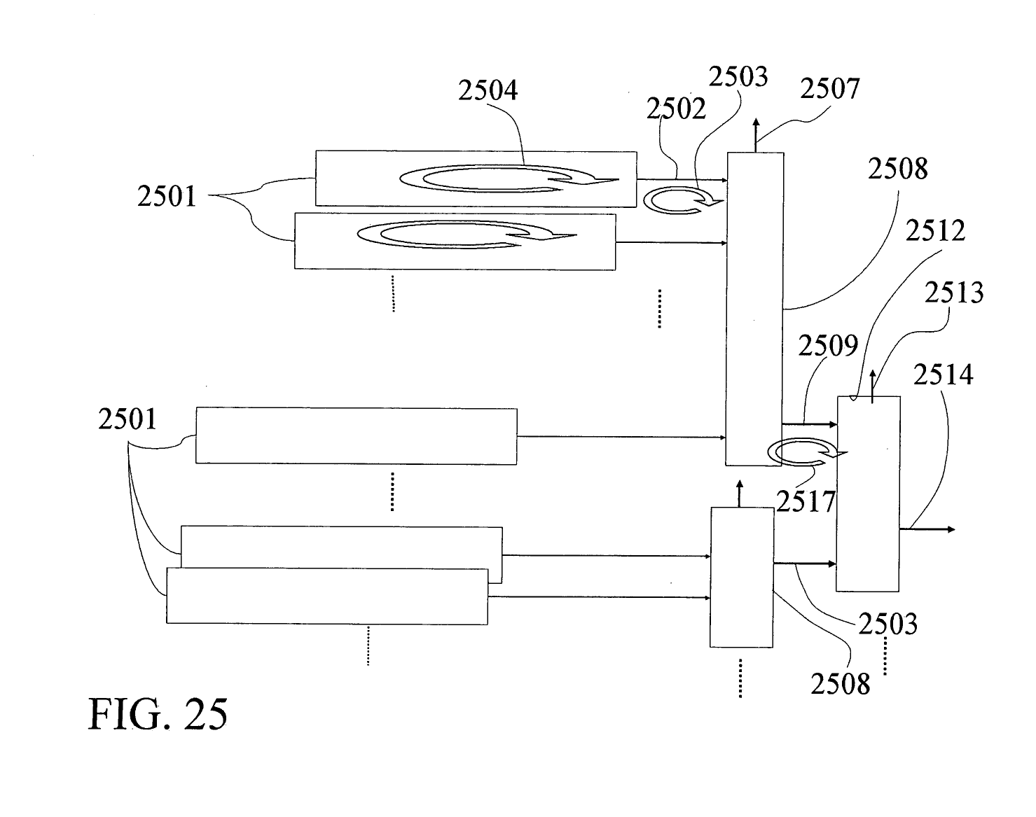

FIG. 25 is a schematic diagram of another embodiment of a device for direct conversion of fission energy into electrical energy in accordance with the present invention. As depicted, multiple units 2501 are connected in parallel to summation devices 2508, which are second level transformer summation units, via the connectors 2502. Each unit 2501 may be similar to the device 2450 in FIG. 24. Each unit 2501 is at the wire-unit level and is connected to one of the second level transformer summation units 2508. At the wire unit level, a current loop 2504 is closed while at the second transformer level the AC current loop 2503 is closed. The second and third level transformer units 2508, 2512 respectively receive transformer control signals 2507, 2513 from a central control unit and transmit to this the parameters of operation up to their level.

The second level transformer summation units 2508 sum outputs from the units 2501 and send the summed energy to the third level transformer unit 2512, closing a new current loop 2503. The third level transformer summation unit 2512 receives its power through conductor 2509 and may send its output current through a conductor 2514 to a unit at a higher level, where the output current may have tens to hundred of volts at few amps. It also closes the current loop 2517. A converter cascade may be used to transform 1-10 mV at the mm³ level into 100-1000V, several KA per reactor module at m³ level, giving powers in MW range. It is noted that other suitable number of units 2501, 2508 may be used without deviating from the spirit of the present teachings.

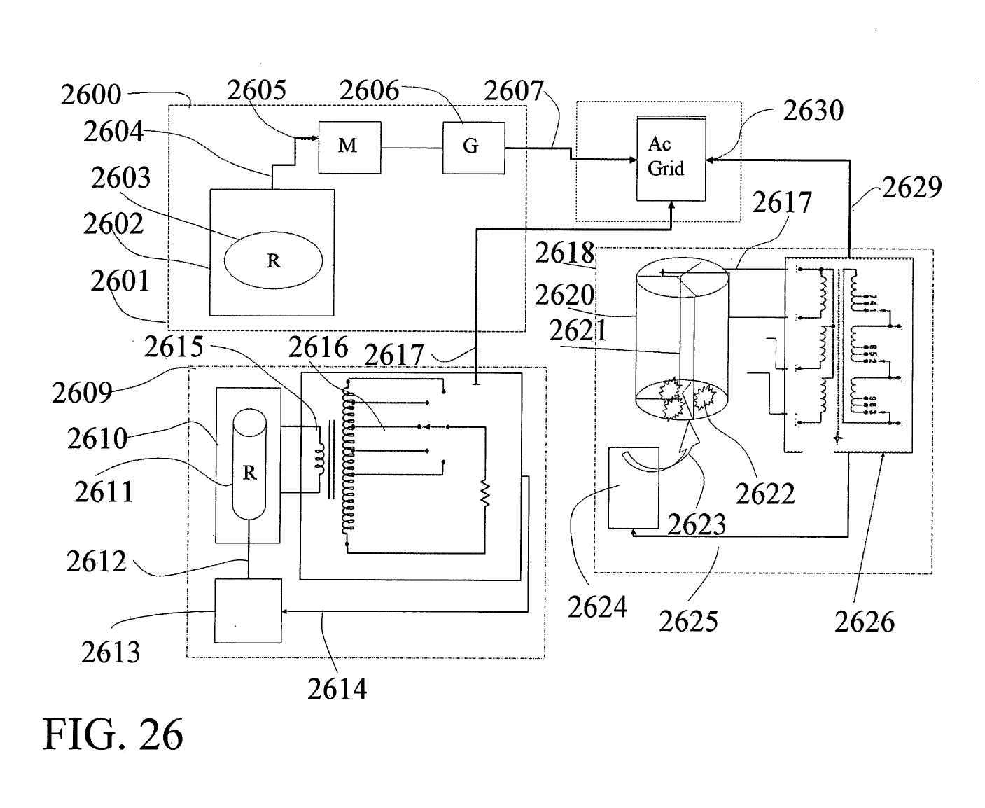

FIG. 26 is a schematic diagram of a nuclear power plant in accordance with the present invention. As depicted, the power plant 2600 includes a first reactor unit 2601 that is based on the classical operating concept. The unit 2601 includes from a reactor shield 2602 that screens the core's 2603 radiations, working with direct conversion using a cascade of power adapters. The reactor's electric output 2604 is input to an electric motor 2605 that drives the generator 2606. The generator 2606 is connected via the distribution cord 2607 to a power grid 2630.

The second reactor structure 2609 is based on the novel principle of accelerator-driven reactivity control to synthesize the grid's frequency and phasing. The structure 2609 includes a reactor's structure 2610 that surrounds the reactor core 2611 having neutron generation area, where the accelerator's beam 2612 induces controlled neutron flux. The reactor 2611 is similar to the reactor described in conjunction with FIG. 16. The accelerator 2613 is controlled by a feedback loop 2614 coupled to a transformer. The reactor 2611, modulated by the accelerator beam, produces a variable power delivered to the primary 2615 of the output transformer. The secondary 2616 of the transformer has a load adaptation, and is connected to the power grid through a cable 2617.

The third reactor unit 2618 includes a reactor sector core 2620 having three sectors 2621. The sectors 2621 are hit separately by the accelerator beam and induce neutron flux 2622. The accelerator beam 2623, coming from an accelerator 2624, changes its impact location continuously, making a nonuniform and variable neutron flux. The accelerator 2624 is controlled by a feedback control loop 2625 to adjust the reactivity, such as reactor voltage 2617 applied to the tri-phased transformer 2626, and thereby to match the power grids needs. The transformer 2626 sends its output to the grid 2630 via a high voltage cable 2629. The reactor 2620 is similar to the reactor of FIG. 16.

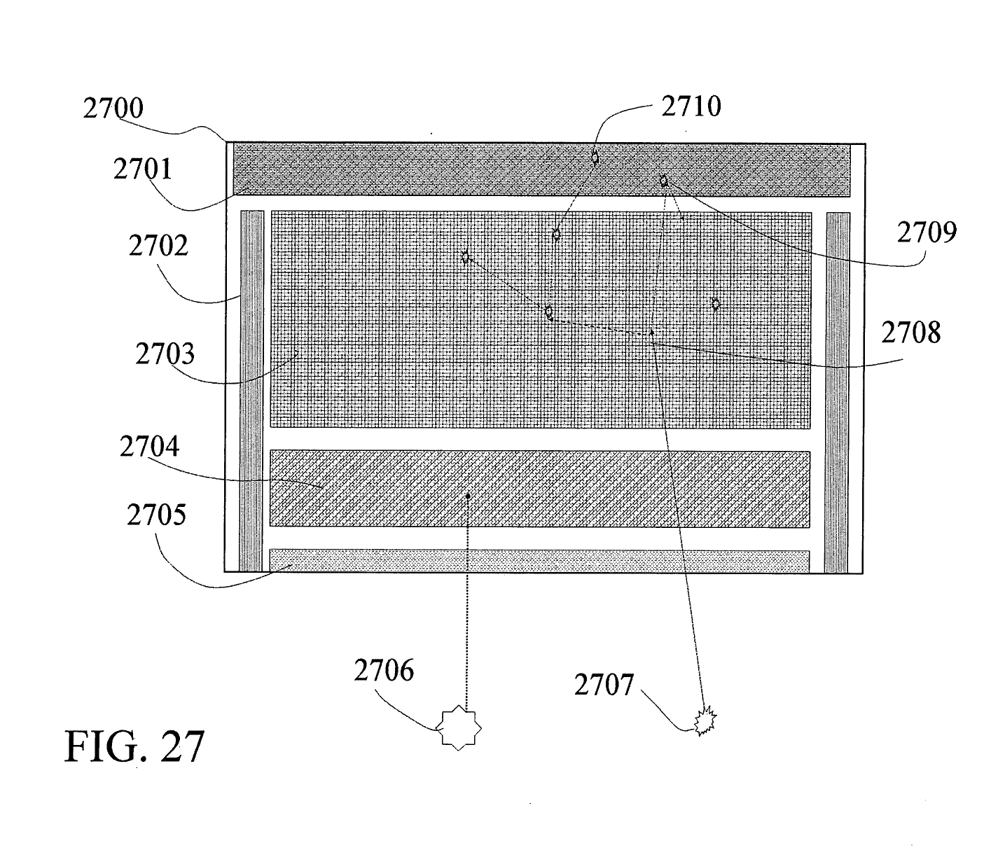

FIG. 27 is a schematic cross sectional diagram of an embodiment of a tile for harvesting fission/fusion/cosmic wind energy in accordance with the present invention. The tile 2700 has a blanket-tile structure and can be used in fission and/or cosmic ray energy harvesting. As depicted, the tile 2700 includes an active layer back shield 2701 that provides bio-protection as well as damps any radiation reaching it. To operate in cryogenic conditions, the tile 2700 may have strong lateral conductor-and-cooling separators 2702. Inside the separators, a neutron-harvesting converter 2703 is positioned in close proximity to the shield 2701. The converter 2703 has a lattice structure and is formed of various chemical compounds that have enhanced collisional cross sections for neutrons. Optionally, the converter 2703 may contain actinides and amplify through fission the neutrons energy. The converter 2703 may have a nano-hetero structure (i.e., the CIci structure). The next nano-hetero structured layer is a charged-particles-and-gamma-rays-electricity converter 2704. Another nano-hetero structured layer 2705, which is a low-energy-charged-particles-and-photons converter, serves as an outer skin of the tile 2700.

A fusion reaction may generate an alpha particle or a triton, called fusion product (He ion) 2706, with energy less than 6 MeV and/or neutrons 2707 with energies less than 15 MeV. The penetration range of the ion is short; typically, the ions stop in the first and second converters 2705, 2704, while the neutrons may travel into the third converter 2703. Due to the large collisional cross section of the actinide content in the layer 2703, the neutrons induce fissions and recoils. The neutrons resulted from a fission reaction 2708 may reach the shield 2701 and thence are reflected at a location 2709, or absorbed by the shield as a location 2710 due to the blanket's high neutron scattering cross-section.

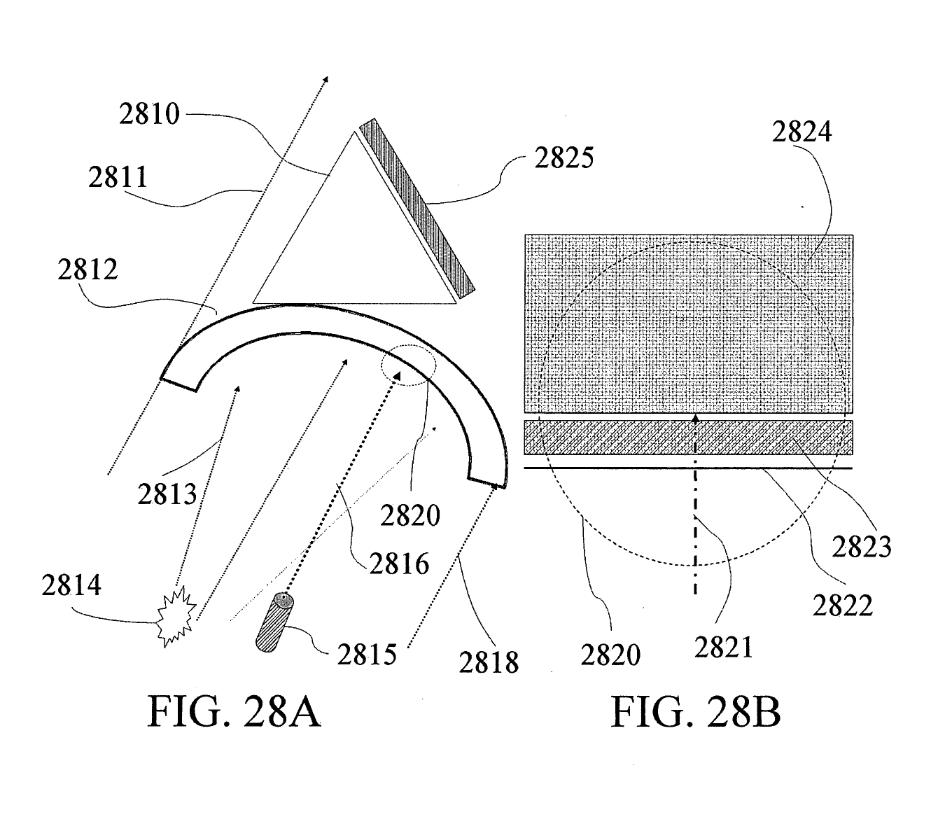

The structure of planar tiles for energy harvesting in space may differ from the hetero-structure used in fission and fusion reactors having another MEMS connector because the voxels, if included in the planar tiles for space application, may be damaged by high-speed dust particles. A space vehicle payload carries protective shields that operate at cryogenic temperature environments and, at the same time, are exposed to high temperatures due to the energy transformation via amorphization in their thermal shield tiles. FIG. 28A shows a schematic diagram of another embodiment of a tile for harvesting fission/cosmic ray energy in accordance with the present invention.

FIG. 28B shows an enlarged view of a portion 2820 in FIG. 28A. As depicted in FIGS. 28A-28B, a space vehicle carries payloads 2810 and includes shields 2812, 2825 for protecting the payloads. When a cosmic particle 2811 hits the shield 2812, it may stop there, giving its energy to the shield that transforms the particle energy into electricity. There is a variety of particles, which are represented by arrows 2813, 2818, 2821, in space that may harm the shuttle and equipment on board. These may have natural origins like cosmic dust, radiations, and particles emitted by sun and stars 2814. Also, an accelerator 2815 outer space located, may emit particles or beams 2816, such as electrons, ions, atoms, or radiations, to power the vehicle. When the particles interact with the shields 2812, 2825, their energy will be harvested into electricity, and its impulse will be used or compensated.

As depicted, the shield 2812 has three layers 2822, 2823, 2824 that may have the same structures and functions as the layers 2705, 2704, 2703 in FIG. 27, respectively. The principle of operation is highlighted in the enlarged area 2820. The energy of the beam 2816 is converted by the outer layer 2822 that stops a portion of the beams in a low energy range, or by middle layer 2823 that stops another portion in a medium energies (in MeV range), such as medium range X-ray and soft gamma radiation. If the beam or particle has energy sufficient enough to pass the second layer 2823, it may be stopped in the third layer 2824. The shields 2812, 2825 are made from reconfigurable tiles module and have a complex shape depending on the needs

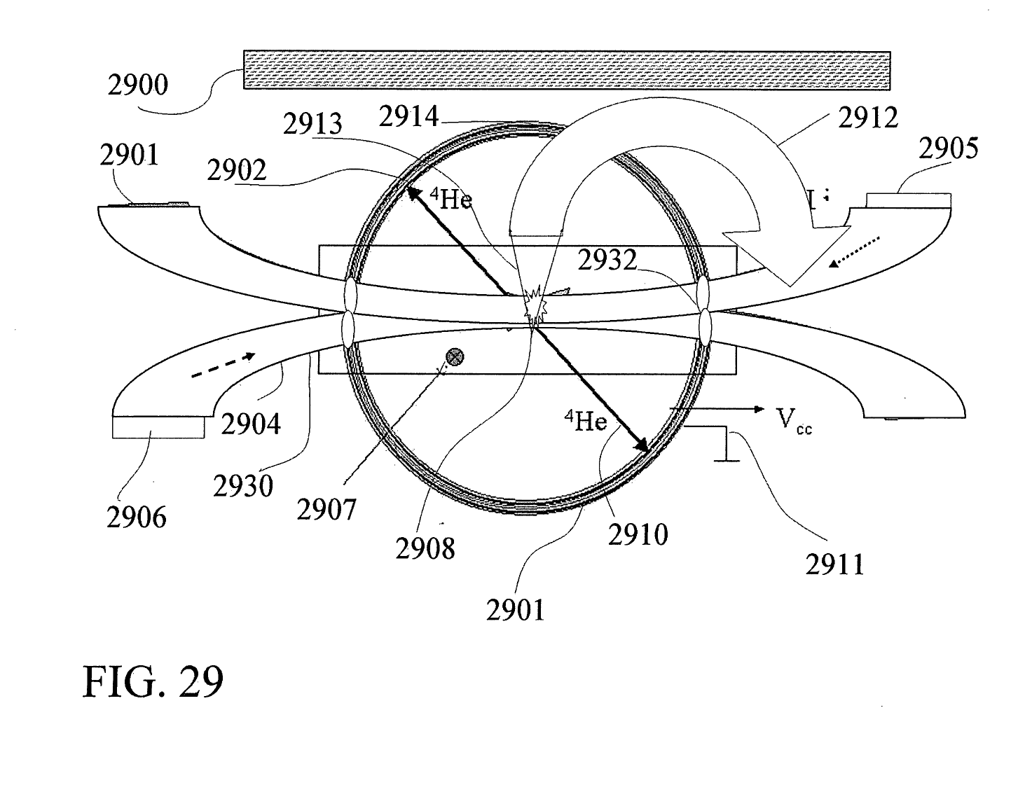

FIG. 29 shows a schematic diagram of an embodiment of a device 2901 for energy harvesting and ion beam propulsion in accordance with the present invention. The device 2901 directly converts fission energy into electrical energy and, when installed in a space vehicle, makes use of fission products to propel the vehicle. As depicted, the device 2901, when carried by a space vehicle, is separated from payloads by a shield 2900 that may be an active shield for heat shielding from hot engine or a passive shield similar to the tile 2700 described in conjunction with FIG. 27. The device 2901 includes a blanket 2902, wherein the blanket 2902 is an active shield that contains no fissile material or a passive shield that includes neutron flux converting materials to harvest the high energy neutrons. Two primary fusion particle beams in two storage rings 2901, 2904 are generated by two storage ring colliders 2905, 2906. The two primary fusion particle beams may be 6-lithium and 2-deuterium beams, for instance, and enter through holes 2930, 2932 formed in the blanket 2902. The particle beam in the storage ring 2901 collides with the counter particle beam that is in the storage ring 2904 and comes from the opposite direction in a speed such that the center of mass is at rest in the space vehicle carrying the device 2900. The focusing and concentration of the collision spot 2908 is done by a magnetic focusing or pinch 2907, which reduces the beam cross sections to enhance particle density at the collision spot 2908.

The fusion products, such as He atoms, fly towards the inner surface of the blanket 2902 as indicated by an arrow 2910. The kinetic energy of fusion products is converted into current by the blanket 2902, where the harvest current 2911 is sent to the shuttle storage or grid. A portion of fusion products, such as He, flying in the most effective solid angle or cone 2913 exits through a hole 2914 formed in the blanket 2902 and is subsequently driven by a magnetic channel 2912. The fusion products exiting the channel 2912 are jettisoned from the space vehicle, which imparts thrust to the vehicle and thereby propel the vehicle in the space.

Depending on the type of particles interacting in fusion reaction or annihilation, the jet propulsion channel is used or not. When electron-positron annihilation is used, the energy-generating device 2902 is used in the entire surrounding sphere to generate electric current by absorbing the 511 KeV gamma rays.

The device 2902 uses hydrogen and lithium isotopes to produce Helium and energy. Some of the hydrogen isotopes react to release high-energy neutrons, as in the case of deuterium-tritium (D-T) reaction. The most easily harvested energy is the kinetic energy of He atoms, while neutrons carry over 50% of the fission energy. To harvest the neutron's energy, a fissile or a high collision cross section material/lattice is preferred. The deuterium-lithium reaction can be used in a hot accelerator structure to prevent Li deposition.

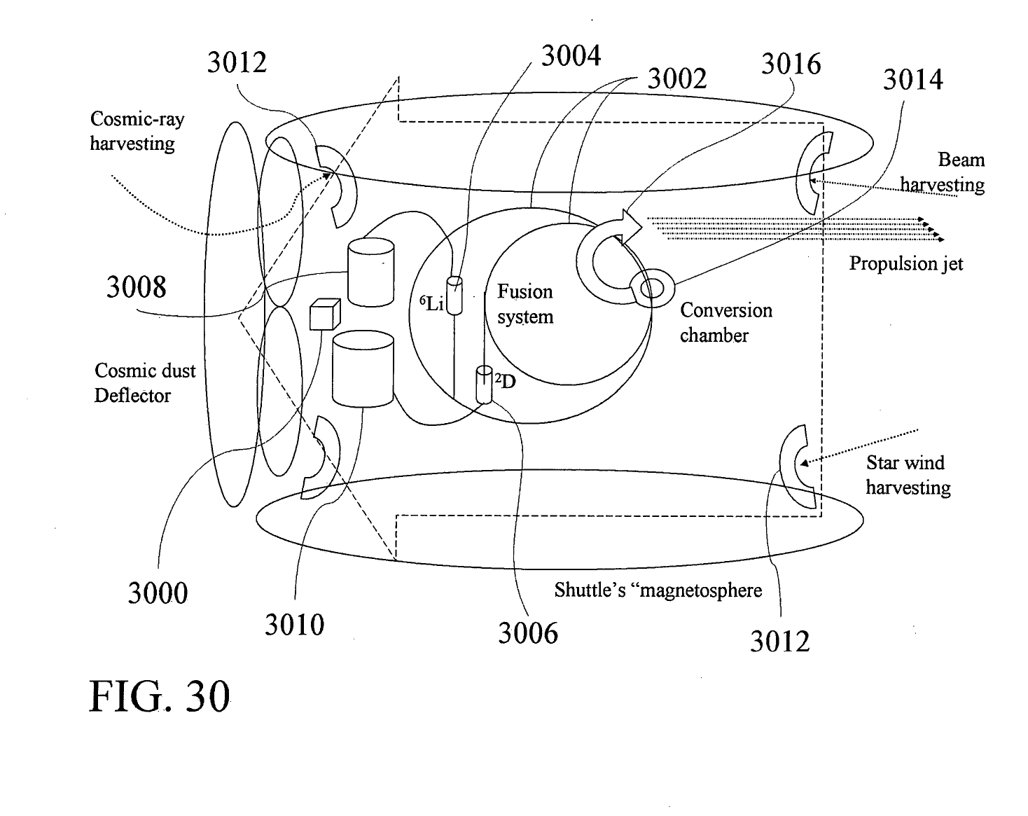

FIG. 30 shows a schematic diagram of a space vehicle having devices in FIGS. 28A-29 in accordance with another embodiment of the present invention. The vehicle includes a device 3014 for energy harvesting and ion beam propulsion, which is similar to the device 2902 in FIG. 29. Two tanks 3008 and 3010 contain the primary fusion particles, such as lithium and deuterium, and transmit the particles to two accelerators or colliders 3004, 3006. The colliders send the fusion particles into two storage rings 3002 to generate fusion reactions in the device 3014. A magnetic channel 3016 steers fusion products exiting from the device 3014 to generate thrust. The blanket of the device 3014 has a nano-hetero structure and is used for the fusion that produces 11 MeV Helium nuclei.

The vehicle also includes multiple shields 3012 that are similar to the shield 2812 in FIG. 28. The shields 3012 harvest the energy of cosmic dust, cosmic ray, star wind particles, or beam/particles emitted by a ground accelerator. The material developed for harvesting the radiation power may not include actinides so that the material does not interact with the neutrons.

The nuclear reactors described in conjunction with FIGS. 17, 26 can be applied to various mobile power generators for ships, submarines, planes, super-trains, or truck trailers (so-called “rolling highway” application). A typical trailer can carry a power plant that has a high-temperature reactor or a direct-conversion reactor and a generation capacity of a few hundred Mw. For space application, the reactor may coexist in the payload 3000 and generate electrical power in the Mw range.

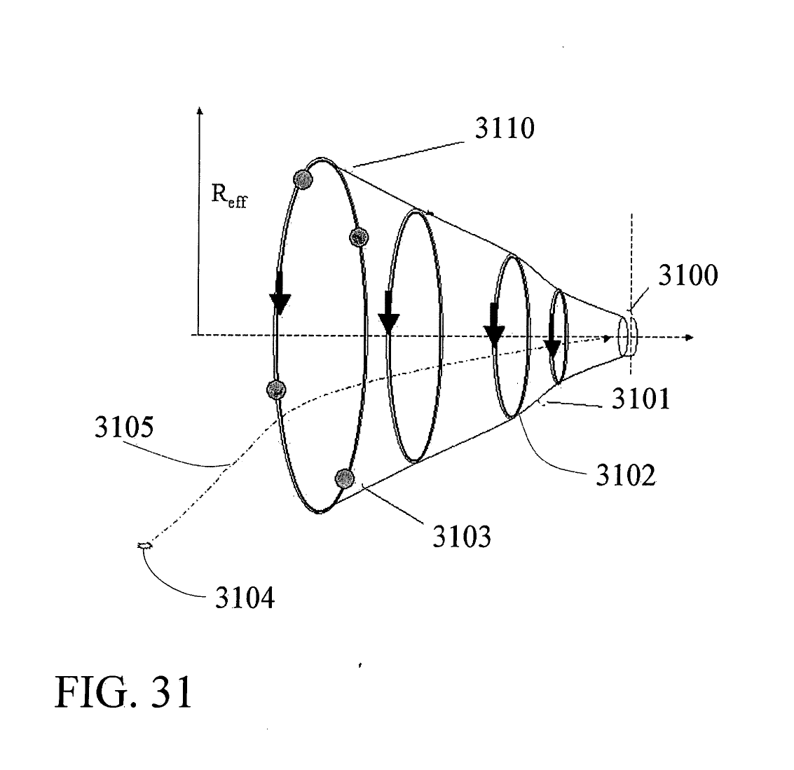

FIG. 31 is a schematic diagram of an embodiment of a device for harvesting cosmic radiation energy in accordance with the present invention. As depicted, a cryogenic tile 3100 is placed at the focal point of a spinning magnetic superconductive FODO (focusing/defocusing) array 3102, wherein each FODO 3101 has a coil 3110 and inertial masses 3103 for centrifugally stabilizing the coil. The particles 3104 are driven by the magnetic field formed by the FODO array 3102 toward a path 3105 to the tile 3100. Typically, the average energy of the space particles is of several tens of nW/m² and the array 3102 may span over hundreds of Km² to harvest several hundred watts. The temperature of the space is about 4K and provides a suitable operational environment for the array 3102 in the supra-conductive domain. The array 3100 may send the collected electrical energy to users in the microwave form based on the Josephson effect.

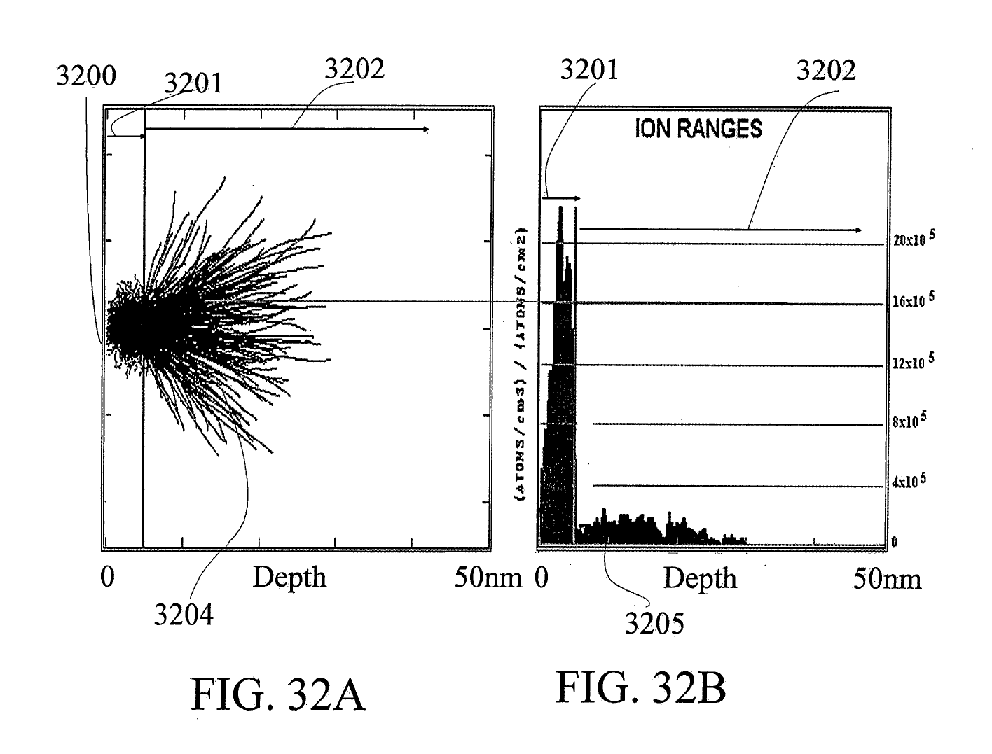

FIG. 32A shows numerically simulated paths 3204 of recoils injected into a bi-layer target. 239U recoils with 10 KeV energy each are injected into the target having uranium metal or grain 3201 washed by water 3202. The uranium metal 3201 and water 3202 are assumed to have thicknesses of 5 nm and 45 nm, respectively. A Monte-Carlo technique has been used to simulate the recoils. The reactions to generate the 239-Uranium compound nucleus are assumed to take place at the initial point 3200 that is in proximity to and outside the surface of the uranium metal. FIG. 32B shows a distribution of 239U recoil stopping density 3205 in the target of FIG. 32A. It is seen that 50% of the compound nuclei do not penetrate the grain and remain as Frenkel defects inside the grain 3201. The extraction efficiency in this case is about 50%-70%, due to uniform distribution of the collision centers all over the grain volume. If the grains are bigger than 5 nm, only a fraction may escape the grain and the extraction efficiency may lower.

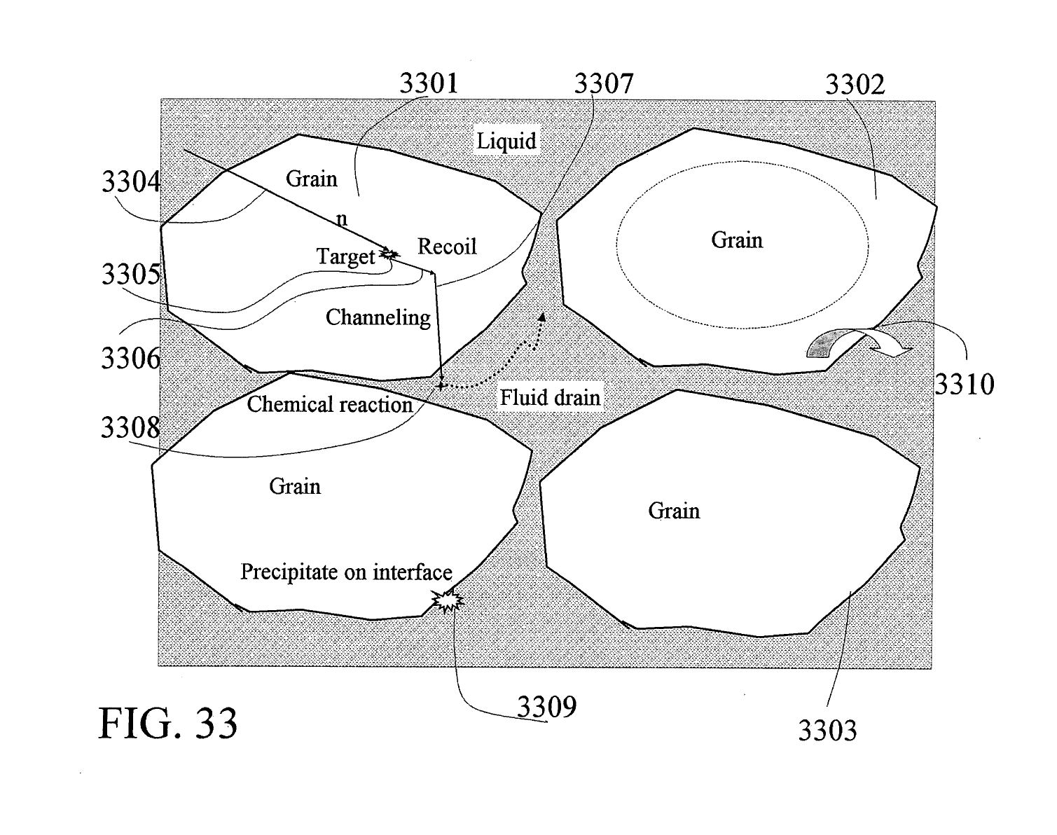

FIG. 33 shows grains 3301 of nuclear fuel immersed in drain liquid 3302. As depicted, the drain liquid 3302, such as water, flows around the nano-sized grains 3301, such as depleted uranium grains in the nanometer range, and thereby washes the grains and carries out the recoiled nuclei 3306. A neutron flying in a direction 3304 interacts with target nuclei 3305, generating an unstable nucleus or recoil that is dislocated from his position in the lattice as indicated by an arrow 3305 and creates an interstitial Frenkel type defect. The interstitial position of the recoil diffuses outside the grain boundary as indicated by an arrow 3307 to meet the drain fluid 3302 and to react with chemicals 3308 floating in the fluid 3308 and thence to be carried outside the nuclear reactor. Depending on the dimensions of the grain, not all of the recoils may reach the grain boundaries but a fraction of them remain in the interface 3310 between the grain and fluid affecting the extraction efficiency. The insulator has the role to prevent the precipitation of the capture and fission products 3309 on the grain's boundary 3303.

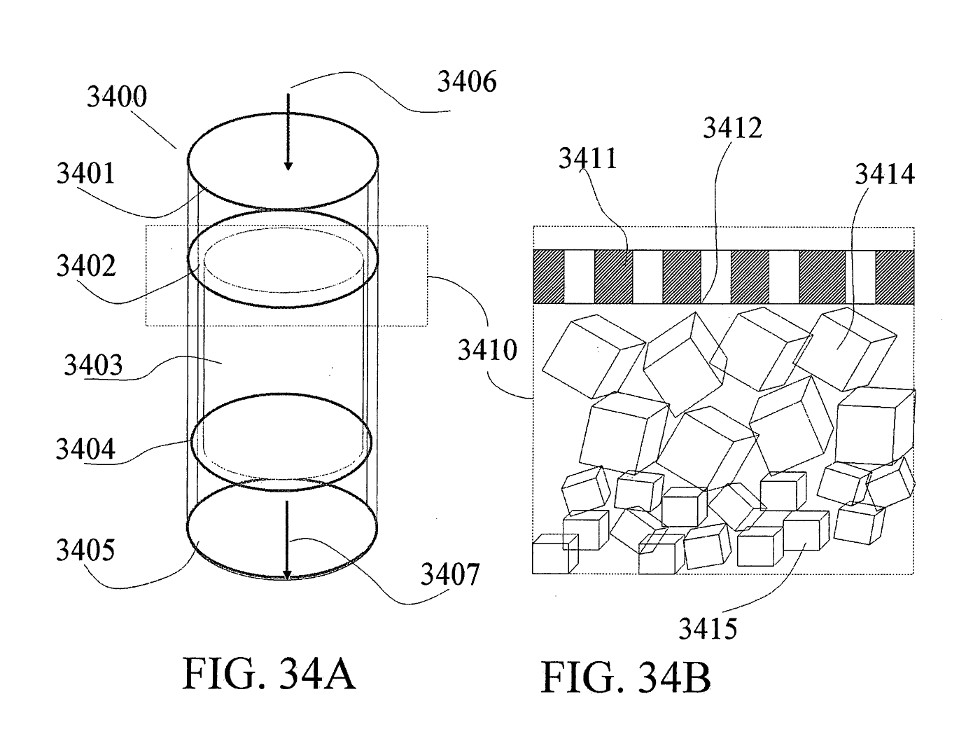

FIG. 34A shows an embodiment of a nuclear pellet 3400 that is compatible with the reaction channel of a nuclear reactor in accordance with the present invention. FIG. 34B is a schematic enlarged view of a portion 3410 of the pellet in FIG. 34A. The pellet 3400 includes fuel grains 3403 having a nano-hetero structure and a cladding 3401 for surrounding the fuel grains. Liquid flow 3406 is introduced inside the cladding so that the liquid washes the grains. The pellet 3400 also includes a metal grid 3402 that stabilize the fuel and are preferably made of aluminum or stainless steel foil 3411 with pores 3412 having a diameter of 100 nm or less.

The grains 3403, made from depleted uranium, Thorium, etc., are contained in the space between the metal grid 3402 and a lower support 3404. The pellet 3400 ends with a connection termination that can be coupled to an input 3401 of another identical pellet. At the bottom of the pellet 3405, the drain liquid exits the pellet as indicated by an arrow 3407 to a purification unit.

The mechanical stability, the grains is obtained by using bigger PM (particle magnitude) grains 3414 near the metallic foil 3411 and smaller grains 3415 in the center as shown in FIG. 34B. The grains are material clusters or can have various shapes and sizes. The drain liquid needs have a good fluidity and does not chemically react with the base isotope but stabilize the recoiled isotope.

The fuel breeding tube gets slightly warm from the incident neutron and the subsequent beta and gamma disintegrations whose energy is few thousand times lower than that in the fission requiring slight cooling system. Its role is to produce controlled nuclear transmutation of the 238-Uranium and 232-Thorium that do not burn in the reactor but are highly abundant in the ore into the highly fissile 239-Plutonium and 233-Uranium extending the planet's nuclear fuel resources by more than 150 times. The advantage of this structure over the actual breeding technology consists in the fact that after the first capture reaction the compound nucleus is removed from the reactor hot zone into separator area and the unwanted reactions of neutron capture driving to 240-Plutonium, 234-Uranium are avoided, giving an extra pure isotope, easy to separate.

While the invention has been described in detail with reference to specific embodiments thereof, it will be apparent to those skilled in the art that various changes and modifications can be made, and equivalents employed, without departing from the scope of the appended claims.

What is claimed is:

1. A nuclear fuel assembly for a nuclear reactor, comprising:
a generally cylindrical elongated tube having an inlet end and a closed opposite end defining an operative portion;
a drain tube disposed within said elongated tube and extending from said inlet end through said operative portion to said closed end, said drain tube having openings along its length for receiving drain fluid; and
means forming at least one fuel layer disposed within said operative portion of said elongated tube, said fuel layer being operative to generate fission products by fission reactions;
whereby drain fluid caused to enter said operative portion through said inlet end passes over the surfaces of said fuel layer, captures the fission products and passes through said openings and thence along the drain tube for discharge therefrom.

2. A nuclear fuel assembly as recited in claim 1, wherein said fuel layer includes a plurality of separated disks stacked along the axial direction of the drain tube and configured to circumscribe the drain tube.

3. A nuclear fuel assembly as recited in claim 1, wherein said fuel layer has a substantially conical shape in a spiral configuration and extends along at least a substantial portion of the operative portion.

4. A nuclear fuel assembly as recited in claim 1, wherein said fuel layer includes a plurality of rectangular plates, each plate having one side aligned along the axial direction of the drain tube.

5. A nuclear fuel assembly as recited in claim 2, wherein the cross-sectional diameter of the cylindrical elongated tube decreases as an axial distance from the inlet increases.

6. A nuclear fuel assembly as recited in claim 5, further including one or more radial levers for pushing the disks along the axial direction toward the inlet end thereby compensating for a loss of reactivity due to a fuel burnup process.

7. A nuclear fuel assembly as recited in claim 2, wherein the thickness of each said disk is less than a flight range, said flight range being a distance that the fission products can move in a fuel formed of the fuel layer.

8. A nuclear fuel assembly as recited in claim 7, wherein each said disk includes a fuel film coated with at least one CIci layer unit and wherein the CIci layer unit includes a high electron density layer, a first insulating layer, a low electron density layer, and a second insulating layer.

9. A nuclear fuel assembly as recited in claim 2, wherein the disk is formed of one or more sub-layers, each sub-layer including a two dimensional mesh made of conducting wires and fuel beads located in knots of the mesh.

10. A nuclear fuel assembly as recited in claim 9, wherein each fuel bead is coated with at least one CIci layer unit and wherein the CIci layer unit includes a high electron density layer, a first insulating layer, a low electron density layer, and a second insulating layer.

11. A nuclear fuel assembly as recited in claim 2, wherein the disk is formed of one or more sub-layers, each sub-layer including a three dimensional mesh made of conducting wires and fuel beads located in knots of the mesh.

12. A nuclear fuel assembly as recited in claim 11, wherein each fuel bead is coated with at least one CIci layer unit and wherein the CIci layer unit includes a high electron density layer, a first insulating layer, a low electron density layer, and a second insulating layer.

13. A device for converting fission energy into electrical energy, comprising:
a fuel layer for generating fission products by fission reactions;
one or more CIci layer units stacked on the fuel layer, each said CIci layer unit including a high electron density layer, a first insulating layer, a low electron density layer, and a second insulating layer; and
an electrical circuit coupled to the high and low electron density layers and operative to harvest electrical energy,
wherein the fission products generate electron showers in the fuel layer and the high electron density layer and wherein the low electron density layer absorbs the electron showers.

14. A tile for converting particle and radiation energy into electrical energy, comprising:
a first layer including one or more CIci layer units, each said CIci layer unit including a high electron density layer, a first insulating layer, a low electron density layer, and a second insulating layer, the first layer being operative to absorb a first portion of particles and radiations moving toward the surface thereof and to convert the energy of the first portion into electrical energy;
a second layer formed over the first layer and including one or more CIci layer units and being operative to absorb a second portion of particles and radiations that have passed through the first layer and to convert the second portion into electrical energy; and
a third layer formed over the second layer and including one or more CIci layer units and operative to capture neutrons that have passed through the first and second layers and to convert the energy of neutrons into electrical energy.

15. A tile as recited in claim 14, further comprising a blanket formed over the third layer and provides bio-protection and damps radiations hitting the surface thereof.

16. A tile as recited in claim 15, wherein the third layer includes actinides and wherein the neutrons and actinides generate fission reactions to amplify the energy of neutrons.

17. A tile as recited in claim 14, wherein the tile operates under a cryogenic environment, further comprising one or more lateral conductor-and-cooling separators surrounding the side edges of the first, second and third layers.

18. A device for converting fusion energy into electrical energy, comprising:
a chamber having a wall comprised of at least one CIci layer unit, the CIci layer unit including a high electron density layer, a first insulating layer, a low electron density layer, and a second insulating layer, the wall having at least two holes facing each other;
two storage ring colliders for respectively sending fusion particle beams into the chamber through the two holes, the two beams traveling in directions opposite to each other; and
means for focusing the two beams onto a collision spot in the chamber so that the two beams make fusion reactions at the spot,
wherein the wall absorbs fusion products generated by the fusion reactions and converts the energy of fusion products into electrical energy.

19. A device as recited in claim 18, wherein the wall has a third hole and the fusion products passing through the third hole are jettisoned from the device to impart propulsion thrust to the device.

20. A nuclear pellet, comprising:
a generally cylindrical cladding layer;
a metal grid covering a first transverse cross section of the cladding layer;
a lower support covering a second transverse cross section of the cladding layer; and
nuclear fuel grains filling a space bounded by the cladding layer, metal grid and lower support and capable of generating transmutation reactions,
wherein liquid flows through the cladding layer and thereby washes the grains and carries recoils generated by the transmutation reactions.
